(19) United States
(12) Patent Application Publication
(10) Pub. No.: US 2006/0083270 A1
(43) Pub. Date: Apr. 20, 2006

(54) Apparatus and method for transmitting/receiving header information in a wireless communication system with a multi-channel structure

(75) Inventors: Sung-Jin Lee, Suwon-si (KR); Young-Kwon Cho, Suwon-si (KR); Katz Marcos Daniel, Suwon-si (KR); Dong-Seek Park, Yongin-si (KR); Jung-Je Son, Seongnam-si (KR); Chang-Hoi Koo, Seongnam-si (KR); Frank Hanns Paul Fitzek, Aalborg (DK); Tatiana Kozlova Madsen, Aalborg (DK); Ramjee Prasad, Aalborg (DK)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/194,438

(22) Filed: Aug. 1, 2005

(30) Foreign Application Priority Data
Jul. 30, 2004 (KR) 2004-60623

(51) Int. Cl. H04J 3/00

(52) U.S. Cl. 370/521

(57) ABSTRACT

An apparatus transmits header information in a wireless communication system using a plurality of channels. In the apparatus, upon receiving uncompressed header (UCH) information, a compressor generates compressed header (CH) information and additional information container (AIC) information by compressing the UCH information with a predetermined compression scheme. A transmitter transmits the CH information through a first channel among the plurality of channels, and transmits the AIC information through at least one of the plurality of channels except for the first channel.

### PRIORITY

This application claims priority under 35 U.S.C. § 119 to an application entitled “Apparatus and Method for Transmitting/Receiving Header Information in a Wireless Communication System with a Multi-Channel Structure” filed in the Korean Intellectual Property Office on Jul. 30, 2004 and assigned Serial No. 2004-60623, the contents of which are incorporated herein by reference.

### BACKGROUND OF THE INVENTION

1. Field of the Invention

The present invention relates generally to an apparatus and method for transmitting/receiving header information in a wireless communication system, and in particular, to an apparatus and method for transmitting/receiving header information in a wireless communication system with a multi-channel structure.

2. Description of the Related Art

With the rapid development of wireless communication systems, high-speed transmission emerges as a very important factor, and a scheme of transmitting/receiving signals using multiple channels is used for the high-speed transmission. By using the multiple channels instead of a single channel, it is possible to transmit/receive a large volume of data at a high speed. The scheme of using multiple channels is classified into a Space Division Multiple Access (SDMA) scheme and a Code Division Multiple Access (CDMA) scheme.

A growing interest in the multi-channel scheme increases an interest in a Multiple Description Coding (MDC) scheme and a Multi-Layered Coding (MLC) scheme. The MDC scheme and the MLC scheme will be described herein below.

1) MDC Scheme

In the MDC scheme, a transmitter segments single source data, for example, video data or audio data into a plurality of descriptors. The transmitter transmits to a receiver over different channels the descriptors, and the receiver can decode the single source data even though it merely receives one of the descriptors. Although the receiver can decode the single source data by merely receiving one descriptor, decoding performance of the single source data for the case where two or more descriptors are received is higher than decoding performance of the single source data for the case where one descriptor is received.

2) MLC Scheme

In the MLC scheme, a transmitter segments information source data into a plurality of entities. That is, the transmitter segments the information source data into two types of entities. The two types include a base layer type and an enhanced layer type. The base layer type represents a type in which a receiver can decode the information source data even though it merely receives the base layer type entity, and the enhanced layer type represents a type in which the receiver receives the enhanced layer type entity after receiving the base layer type entity, thereby improving decoding performance. When only the enhanced layer type entity is received before the base layer type entity is received, the receiver cannot decode the information source data.

In the wireless communication system, transmission/reception of header information is essential, but the transmission/reception of the header information serves as overhead of the wireless communication system. In particular, because header information in a communication system using an Internet protocol (IP) scheme (IP communication system), which is a wireless communication system, is large in size based on a characteristic of the IP communication system. The header information serves as higher overhead. In the IP communication system, it is very important to compress the header information to improve the performance thereof.

With reference to FIGS. 1 and 2, a description will now be made of the overhead of the header information in the IP communication system.

FIG. 1 is a diagram illustrating the overhead of the header information in a conventional IP communication system using an IP version 4 scheme (hereinafter referred to as an “IPv4 communication system”).

As illustrated in FIG. 1, when a Real Time Protocol (RTP) scheme, a User Datagram Protocol (UDP) scheme, and the IPv4 scheme are used for a multimedia service, the header information has a 40-byte overhead in the IPv4 communication system.

The header information is comprised of RTP header information 100 for the RTP scheme, UDP header information 130 for the UDP scheme, and IPv4 header information 160 for the IPv4 scheme Because the RTP header information 100 has 12 bytes, the UDP header information 130 has 8 bytes, and the IPv4 header information 160 has 20 bytes, the header information has a total of 40 bytes. In FIG. 1, the parameters that make up the header information are not directly related to the present invention, so a detailed description thereof will be omitted herein.

The overhead of header information in the conventional IPv4 communication system has been described with reference to FIG. 1. Next, a description will be made of overhead of header information in a conventional IP communication system using an IP version 6 scheme (hereinafter referred to as an “IPv6 communication system”).

FIG. 2 is a diagram illustrating the overhead of the header information in a conventional IPv6 communication system.

As illustrated in FIG. 2, when the RTP scheme, the UDP scheme, and the IPv6 scheme are used for a multimedia service, the header information has a 60-byte overhead in the IPv6 communication system.

The header information is comprised of is comprised of RTP header information 200 for the RTP scheme, UDP header information 230 for the UDP scheme, and IPv6 header information 260 for the IPv6 scheme. Because the RTP header information 200 has 12 bytes, the UDP header information 230 has 8 bytes, and the IPv6 header information 260 has 40 bytes, the header information has a total of 60 bytes. In FIG. 2, the parameters that make up the header information are not directly related to the present invention, so a detailed description thereof will be omitted herein.

When real-time voice communication is performed in the IP communication system, the overhead of the header information further increases because a payload size for the real-time voice communication is small. However, when video communication is performed in the IP communication system, the overhead of the header information is less than that for the real-time voice communication. Although small, the overhead of the header information for the video communication is not negligible.

With reference to FIGS. 3 and 4, a detailed description will now be made of overhead of header information in the IP communication system.

FIG. 3 is a graph illustrating overhead of header information with respect to the number of sub-streams in the conventional IPv4 communication system.

In FIG. 3, a relationship between the number of sub-streams, i.e., descriptors, and the amount of overhead header information is shown. Specifically, FIG. 3 shows the overhead of the header information for the case where 3 quantized values of QP1, QP31 and QP51 are used. It is assumed that the sub-streams shown in FIG. 3 have a Foreman quarter common intermediate format (QCIF). In FIG. 3, ‘QP X’ represents the encoding overhead for a quantization level X, and ‘QP X+N’ represents a sum of the encoding overhead for the quantization level X and the network overhead of the IPv4 communication system. As shown in FIG. 3, because the overhead of the header information abruptly increases by the network overhead rather than the quantization level, restriction of the quantization level is minimized.

FIG. 4 is a graph illustrating overhead of header information with respect to the number of sub-streams in the conventional IPv6 communication system.

In FIG. 4, a relationship between the number of sub-streams, i.e., descriptors, and the overhead header information is shown. Specifically, FIG. 4 shows the overhead of the header information for the case where 3 quantized values of QP1, QP31 and QP51 are used. It is assumed that the sub-streams shown in FIG. 4 have a Foreman QCIF. Similarly, it can be understood from FIG. 4 that the overhead of the header information abruptly increases by the network overhead rather than the quantization level in the IPv6 communication system.

As described with reference to FIGS. 3 and 4, the overhead of the header information is a factor that must be considered in performing multi-channel communication, like in the MDC scheme. Therefore, there is a need for a header information compression scheme.

FIG. 5 is a diagram illustrating a structure of a transceiver for an IP communication system using a conventional header compression scheme.

Referring to FIG. 5, if there is header information, a transmitter delivers the header information to a compressor 500, and the compressor 500 compresses the header information according to a compression scheme. Although not illustrated in FIG. 5, the header information compressed by the compressor 500 is transmitted to a receiver (not shown) through the transmitter. In the IP communication system, redundancy information is included in header information as described with reference to FIGS. 1 and 2. The header information compression scheme generates header information using only required information except for the redundancy information. In the following description, header information that is not compressed will be referred to as an “UnCompressed Header (UCH),” and the header information will be referred to as a “Compressed Header (CH).”

The receiver receives the CH information transmitted by the transmitter, and delivers the received CH information to a decompressor 550. The decompressor 550 decompresses the CH information into its original header information, i.e. UCH information, with a decompression scheme corresponding to the header compression scheme used in the transmitter.

A delta coding scheme can be used as the header compression scheme.

FIG. 6 is a diagram illustrating a delta coding scheme in a conventional IP communication system with a single-channel structure.

Referring to FIG. 6, in the delta coding scheme, when the header information, i.e. UCH information (1,1), is received, only the variable information in the UCH information (1,1) is transmitted and the variable information becomes the CH information. Assuming that the header information is transmitted at N time slots constituting one frame, UCH information (1,1) is transmitted at a first time slot of the frame, and CH information (1,2), CH information (1,3), CH information (1,n), CH information (1,N−1) and CH information (1,N), all of which are expressed with only the variable information in the UCH information (1,1), are transmitted at the remaining (N−−1) time slots. In the UCH information (i,n) and the CH information (i,n), ‘i’ denotes a frame index and ‘n’ denotes a time slot index. Therefore, the UCH information (i,n) represents UCH information at an n^{th} time slot of an i^{th} frame, and the CH information (i,n) represents CH information at an n^{th} time slot of an i^{th} frame.

As described with reference to FIG. 6, the delta coding scheme transmits only the variable information data in the original information data, and it is possible to reduce the overhead caused by the transmission of the header information by transmitting the header information using the delta coding scheme. In addition, the delta coding scheme can guarantee lower complexity and higher performance, so it is popularly used as the header information compression scheme.

FIG. 7 is a diagram illustrating a delta coding scheme in a conventional IP communication system with a multi-channel structure.

Before a description of FIG. 7 is given, it will be assumed that the IP communication system has a multi-channel structure in which J channels are used. Referring to FIG. 7, because the IP communication system has a multi-channel structure, UCH information for each of the J channels, i.e. UCH information (1,1,1), UCH information (j,1,1), and UCH information (J,1,1), are received. Herein, only a first channel will be described for simplicity. During a first frame of the first channel, if the UCH information (1,1,1) is received, variable information in the UCH information (1,1,1), i.e. CH information (1,1,2), CH information (1,1,3), CH information (1,1,n), CH information (1,1,N−1), and CH information (1,1,N), are transmitted. That is, for N time slots constituting the first frame of the first channel, the UCH information (1,1,1) is transmitted at a first time slot of the first frame, and the CH information (1,1,2), the CH information (1,1,3), the CH information (1,1,n), the CH information (1,1,N−1) and the CH information (1,1,N), all of which are expressed with only the variable information in the UCH information (1,1,1), are transmitted at the remaining (N−1) time slots. In the UCH information (j,i,n) and the CH information (j,i,n), ‘j’ denotes a channel index. The UCH information “(j,i,n)” represents UCH information at an n^{th} time slot in an i^{th} frame of a j^{th} channel, and the CH information “(j,i,n)” represents CH information at an n^{th} time slot in an i^{th} frame of a j^{th} channel.

FIG. 8 is a diagram illustrating an operation of the delta coding scheme of FIG. 7 in case of errors.

Referring to FIG. 8, it will first be assumed that an error has occurred in CH information (1,1,N−1) of a first frame, i.e. Frame(1,1), of a first channel. CH information before the defective CH information (1,1,N−1) can be restored, and CH information after the defective CH information (1,1,N−1), i.e. CH information (1,1,N), cannot be restored due to the error that occurred in the CH information (1,1,N−1), although it has been normally received. It will also be assumed that an error has occurred in UCH information (j,1,1) of a first frame of an arbitrary channel, i.e. Frame(j,1). Because an error has occurred in the UCH information (j,1,1), i.e. because an error has occurred in the original header information, CH information after the UCH information (j,1,1), i.e. CH information (j,1,2), CH information (j,1,3), CH information (j,1,n), CH information(j,1,N−1), and CH information (j,1,N), cannot be normally restored, although they have been normally received. As a result, header information of the Frame(j,1) cannot be normally restored because the UCH information (j,1,1), the CH information (j,1,2), the CH information (j,1,3), the CH information (j,1,n), the CH information (j,1,N−1), and the CH information (j,1,N) cannot be restored. It will further be assumed that an error has occurred in CH information (J,1,N) out of CH information of a first frame of a J^{th} channel, i.e. Frame(J,1). CH information before the defective CH information (J,1,N) can be restored, and only the CH information (J,1,N) cannot be restored due to the error occurred therein.

As described with reference to FIG. 8, when an error has occurred in UCH information, all of the CH information after the UCH information suffers restoration failure. Therefore, compared with the error that occurred in the CH information, the error that occurred in the UCH information is more fatal to normal information restoration.

If an error occurs during the transmission/reception of the CH information, it is not possible to correctly detect the CH information, causing a failure in the data transmission/reception. Therefore, there is a need for a header compression scheme capable of guaranteeing reliability of the CH information. To meet this need, a Robust Header Compression (ROHC) scheme has been proposed as a new header compression scheme. However, the ROHC scheme requires a high-capacity memory and requires a feedback channel, increasing its complexity. In addition, no detailed method for applying the ROHC scheme to the RTP/UDP/IP schemes has been devised.

### SUMMARY OF THE INVENTION

Although there are numerous header information compression schemes in addition to the delta coding scheme and the ROHC scheme, all of the header information compression schemes that have been proposed are applied to the single-channel structure. As described above, however, for the high-speed, high-capacity service, it is necessary to use multiple channels. Of course, it is possible to simply apply the header information compression schemes to a multi-channel structure. However, if the header information compression schemes are simply applied without taking into account the multi-channel structure, their performances cannot be guaranteed. Therefore, there is a demand for a header compression scheme appropriate for the multi-channel structure, and a method for transmitting/receiving CH information.

It is, therefore, an object of the present invention to provide an apparatus and method for transmitting/receiving header information after compression in a wireless communication system.

It is another object of the present invention to provide an apparatus and method for transmitting/receiving compressed header (CH) information in a wireless communication system with a multi-channel structure.

It is further another object of the present invention to provide an apparatus and method for transmitting/receiving header information after compression with reliability in a wireless communication system.

According to one aspect of the present invention, there is provided an apparatus for transmitting header information in a wireless communication system using a plurality of channels. The apparatus includes a compressor for, upon receiving uncompressed header (UCH) information, generating compressed header (CH) information and additional information container (AIC) information by compressing the UCH information; and a transmitter for transmitting the CH information through a first channel among the plurality of channels, and transmitting the AIC information through at least one of the plurality of channels except for the first channel.

According to another aspect of the present invention, there is provided an apparatus for transmitting header information in a wireless communication system using a plurality of channels. The apparatus includes a compressor for, upon receiving uncompressed header (UCH) information, generating compressed header (CH) information and additional information container (AIC) information by compressing the UCH information; and a transmitter for transmitting the CH information through a first channel among the plurality of channels, and transmitting the AIC information through at least one channel related to the first channel among the plurality of channels except for the first channel.

According to further another aspect of the present invention, there is provided an apparatus for transmitting header information in a wireless communication system using a plurality of channels. The apparatus includes a compressor for, upon receiving uncompressed header (UCH) information to be transmitted through a first channel among the plurality of channels, generating compressed header (CH) information by compressing the UCH information, and upon receiving UCH information to be transmitted through each of the plurality of channels except for the first channel, generating additional information container (AIC) information for each of the plurality of channels except for the first channel by compressing the UCH information to be transmitted through each of the plurality of channels except for the first channel, with the compression scheme; and a transmitter for transmitting the CH information and the AIC information through the first channel.

According to yet another aspect of the present invention, there is provided an apparatus for transmitting header information in a wireless communication system using a plurality of channels. The apparatus includes a compressor for, upon receiving uncompressed header (UCH) information to be transmitted through a first channel among the plurality of channels, generating compressed header (CH) information by compressing the UCH information, and upon receiving UCH information to be transmitted through each of the channels related to the first channel among the plurality of channels, generating additional information container (AIC) information for each of the related channels by compressing the UCH information to be transmitted through the related channels; and a transmitter for transmitting the CH information and the AIC information through the first channel.

According to still another aspect of the present invention, there is provided an apparatus for receiving header information in a wireless communication system using a plurality of channels. The apparatus includes a receiver for receiving compressed header (CH) information through a first channel among the plurality of channels, the CH information being generated by compressing uncompressed header (UCH) information, and receiving additional information container (AIC) information through the plurality of channels except for the first channel, the AIC information being generated by compressing the UCH information; and a decompressor for restoring the CH information into the UCH information by decompressing the CH information.

According to still another aspect of the present invention, there is provided an apparatus for receiving header information in a wireless communication system using a plurality of channels. The apparatus includes a receiver for receiving compressed header (CH) information through a first channel among the plurality of channels, the CH information being generated by compressing uncompressed header (UCH) information, and receiving additional information container (AIC) information through the channels related to the first channel among the plurality of channels, the AIC information being generated by compressing the UCH information; and a decompressor for restoring the CH information into the UCH information by decompressing the CH information.

According to still another aspect of the present invention, there is provided a method for transmitting header information in a wireless communication system using a plurality of channels. The method includes the steps of, upon receiving uncompressed header (UCH) information, generating compressed header (CH) information and additional information container (AIC) information by compressing the UCH information; and transmitting the CH information through a first channel among the plurality of channels, and transmitting the AIC information through at least one of the plurality of channels except for the first channel.

According to still another aspect of the present invention, there is provided a method for transmitting header information in a wireless communication system using a plurality of channels. The method includes the steps of, upon receiving uncompressed header (UCH) information, generating compressed header (CH) information and additional information container (AIC) information by compressing the UCH information; and transmitting the CH information through a first channel among the plurality of channels, and transmitting the AIC information through at least one channel related to the first channel among the plurality of channels except for the first channel.

According to still another aspect of the present invention, there is provided a method for transmitting header information in a wireless communication system using a plurality of channels. The method includes the steps of, upon receiving uncompressed header (UCH) information to be transmitted through a first channel among the plurality of channels, generating compressed header (CH) information by compressing the UCH information; upon receiving UCH information to be transmitted through each of the plurality of channels except for the first channel, generating additional information container (AIC) information for each of the plurality of channels except for the first channel by compressing the UCH information to be transmitted through each of the plurality of channels except for the first channel; and transmitting the CH information and the AIC information through the first channel,

According to still another aspect of the present invention, there is provided a method for transmitting header information in a wireless communication system using a plurality of channels. The method includes the steps of upon receiving uncompressed header (UCH) information to be transmitted through a first channel among the plurality of channels, generating compressed header (CH) information by compressing the UCH information; upon receiving UCH information to be transmitted through each of the channels related to the first channel among the plurality of channels, generating additional information container (AIC) information for each of the related channels by compressing the UCH information to be transmitted through the related channels; and transmitting the CH information and the AIC information through the first channel.

According to still another aspect of the present invention, there is provided a method for receiving header information in a wireless communication system using a plurality of channels. The method includes the steps of receiving compressed header (CH) information through a first channel among the plurality of channels, the CH information being generated by compressing uncompressed header (UCH) information; receiving additional information container (AIC) information through the plurality of channels except for the first channel, the AIC information being generated by compressing the UCH information; and restoring the CH information into the UCH information by decompressing the CH information.

According to still another aspect of the present invention, there is provided a method for receiving header information in a wireless communication system using a plurality of channels. The method includes the steps of receiving compressed header (CH) information through a first channel among the plurality of channels, the CH information being generated by compressing uncompressed header (UCH) information; receiving additional information container (AIC) information through the channels related to the first channel among the plurality of channels, the AIC information being generated by compressing the UCH information; and restoring the CH information into the UCH information by decompressing the CH information.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating overhead of header information in a conventional IPv4 communication system;

FIG. 2 is a diagram illustrating overhead of header information in a conventional IPv6 communication system;

FIG. 3 is a graph illustrating overhead of header information with respect to the number of sub-streams in the conventional IPv4 communication system;

FIG. 4 is a graph illustrating overhead of header information with respect to the number of sub-streams in the conventional IPv6 communication system;

FIG. 5 is a diagram illustrating a structure of a transceiver for an IP communication system using a conventional header compression scheme;

FIG. 6 is a diagram illustrating a delta coding scheme in a conventional IP communication system with a single-channel structure;

FIG. 7 is a diagram illustrating a delta coding scheme in a conventional IP communication system with a multi-channel structure;

FIG. 8 is a diagram illustrating an operation of the delta coding scheme of FIG. 7 in case of errors;

FIG. 9 is a diagram illustrating a header information compression scheme in an IP communication system with a multi-channel structure according to embodiments of the present invention;

FIG. 10 is a diagram illustrating a structure of a header information compressor for compressing header information using a mode-A scheme in a transmitter for an IP communication system with a multi-channel structure according to a first embodiment of the present invention;

FIG. 11 is a diagram illustrating a structure of a header information compressor for compressing header information using a mode-B scheme in a transmitter for an IP communication system with a multi-channel structure according to the first embodiment of the present invention;

FIG. 12 is a diagram illustrating a header information compression scheme in an IP communication system with a multi-channel structure according to the first embodiment of the present invention;

FIG. 13 is a diagram illustrating an operation of the header information compression scheme of FIG. 12 in case of errors;

FIG. 14 is a diagram illustrating a header information compression scheme in an IP communication system with a multi-channel structure according to a second embodiment of the present invention;

FIG. 15 is a diagram illustrating an operation of the header information compression scheme of FIG. 14 in case of errors;

FIG. 16 is a graph illustrating a PEP for a channel error probability equal to 1% in an IP communication system according to the first embodiment of the present invention;

FIG. 17 is a graph illustrating a PEP for a channel error probability equal to 5% in an IP communication system according to the first embodiment of the present invention;

FIG. 18 is a graph illustrating a PEP for a channel error probability equal to 10% in an IP communication system according to the first embodiment of the present invention;

FIG. 19 is a diagram illustrating a relationship between a PEP and the number J of channels and a frame length N for p=0.05 in an IP communication system according to the first embodiment of the present invention;

FIG. 20 is a diagram illustrating a relationship between a PEP and the number J of channels and a frame length N for p=0.01 in an IP communication system according to the first embodiment of the present invention;

FIG. 21 is a diagram illustrating a relationship between efficiency and the number J of channels and a frame length N for p=0.05 and a packet length of 30 bytes in an IP communication system according to the first embodiment of the present invention;

FIG. 22 is a diagram illustrating a relationship between efficiency and the number J of channels and a frame length N for p=0.01 and a packet length of 30 bytes in an IP communication system according to the first embodiment of the present invention;

FIG. 23 is a diagram illustrating a relationship between efficiency and the number J of channels and a frame length N for p=0.05 and a packet length of 1460 bytes in an IP communication system according to the first embodiment of the present invention;

FIG. 24 is a diagram illustrating a relationship between efficiency and the number J of channels and a frame length N for p=0.01 and a packet length of 1460 bytes in an IP communication system according to the first embodiment of the present invention;

FIG. 25 is a diagram illustrating efficiency for p=0.05 and a payload length of 1460 bytes in an IP communication system according to the first embodiment of the present invention;

FIG. 26 is a diagram illustrating efficiency for p=0.05 and a payload length of 30 bytes in an IP communication system according to the first embodiment of the present invention;

FIG. 27 is a graph illustrating overhead of header information with respect to the number of sub-streams in an IP communication system in which the scheme according to the first embodiment of the present invention is used as the header compression scheme;

FIG. 28 is a graph illustrating a PEP for a channel error probability equal to 1% in an IP communication system according to a second embodiment of the present invention;

FIG. 29 is a graph illustrating a PEP for a channel error probability equal to 5% in an IP communication system according to the second embodiment of the present invention;

FIG. 30 is a graph illustrating a PEP for a channel error probability equal to 10% in an IP communication system according to the second embodiment of the present invention;

FIG. 31 is a diagram illustrating a relationship between a PEP and the number J of channels and a frame length N for p=0.1 in an IP communication system according to the second embodiment of the present invention;

FIG. 32 is a diagram illustrating a relationship between efficiency and the number J of channels and a frame length N for p=0.1 and a packet length of 30 bytes in an IP communication system according to the second embodiment of the present invention;

FIG. 33 is a diagram illustrating a relationship between efficiency and the number J of channels and a frame length N for p=0.1 and a packet length of 1460 bytes in an IP communication system according to the second embodiment of the present invention;

FIG. 34 is a diagram illustrating efficiency for p=0.05 and a payload length of 1460 bytes in an IP communication system according to the second embodiment of the present invention;

FIG. 35 is a diagram illustrating efficiency for p=0.05 and a payload length of 30 bytes in an IP communication system according to the second embodiment of the present invention;

FIG. 36 is a graph illustrating an impact of the number J of channels used in embodiments of the present invention for a fixed D and a fixed p;

FIG. 37 is a graph illustrating an impact of MAC packet error probability in an IP communication system according to embodiments of the present invention; and

FIG. 38 is a graph illustrating an impact of a segmentation level in an IP communication system according to embodiments of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

The present invention proposes an apparatus and method for transmitting/receiving header information after compression in a wireless communication system with a multi-channel structure. In particular, the present invention proposes an apparatus and method for compressing information indicating a part of header information of another channel except for a corresponding channel, i.e. an additional information container (AIC), along with header information for each of a plurality of channels, before transmission, thereby increasing reliability of the header information. It will be assumed herein that a communication system using an Internet protocol (IP) scheme (IP communication system) is used as the wireless communication system. In addition, it will be assumed that one frame of the IP communication system is comprised of N time slots.

The present invention proposes two embodiments according to a scheme of transmitting the AIC that is transmitted along with the header information. A first embodiment of the present invention provides a scheme of copying the AIC in all of the parallel channels except for a corresponding channel, before transmission, and a second embodiment of the present invention provides a scheme of copying the AIC in only the channels related to a corresponding channel, and not the corresponding channel, before transmission.

In addition, the present invention proposes two schemes of encoding the AIC, i.e. a mode-A scheme and a mode-B scheme. The mode-A scheme directly generates an AIC corresponding to UnCompressed Header (UCH) information or Compressed Header (CH) information in a corresponding channel and delivers the generated AIC to the channels that will transmit the AIC. The mode-B scheme delivers UCH information or CH information to the channels that will transmit the AIC, in a corresponding channel, and generates the AIC using received UCH information or CH information in the channels through which the UCH information or the CH information were received.

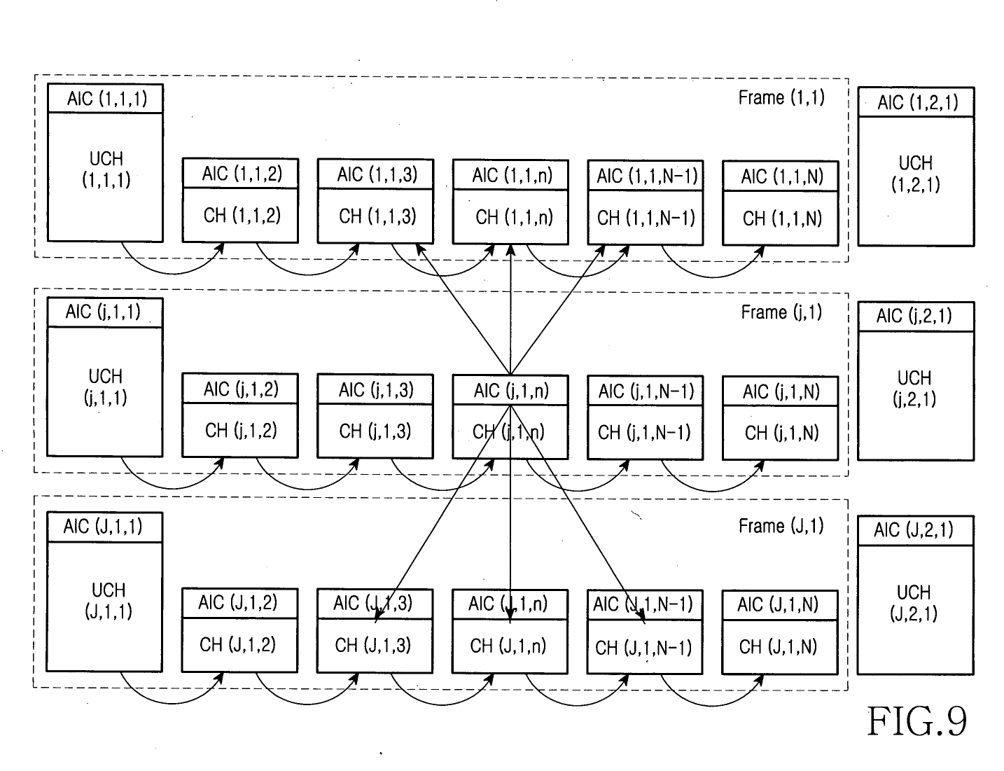

FIG. 9 is a diagram illustrating a header information compression scheme in an IP communication system with a multi-channel structure according to embodiments of the present invention.

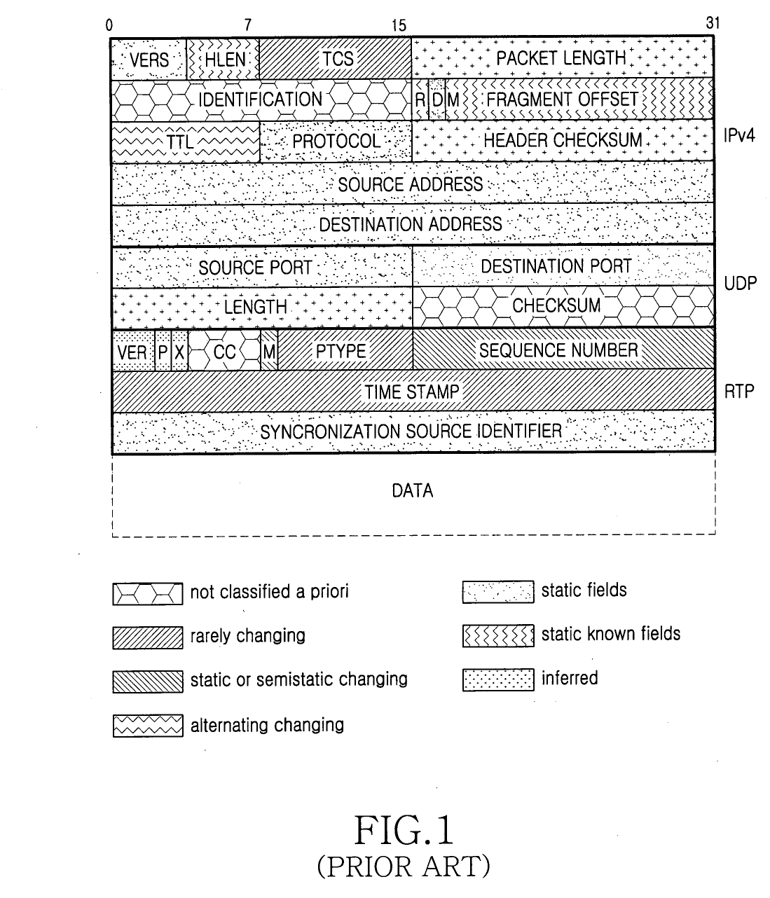

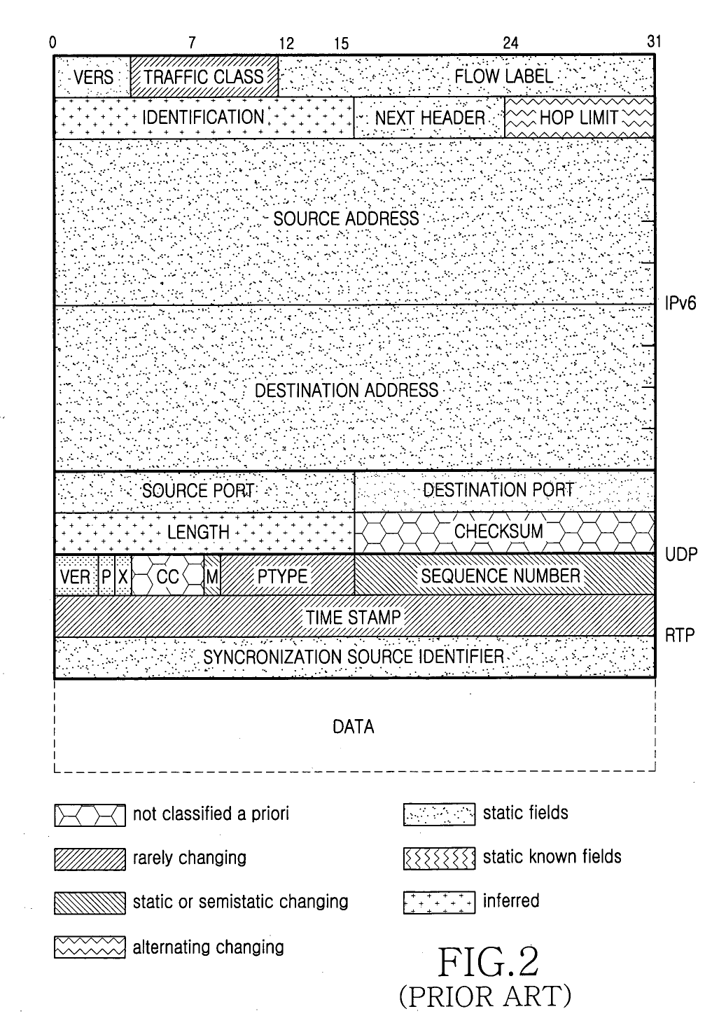

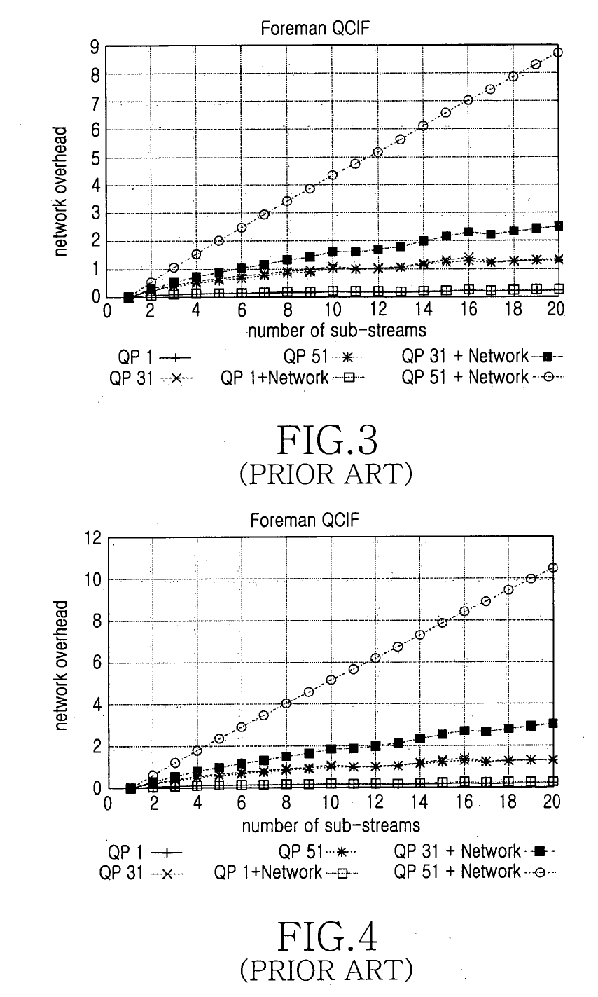

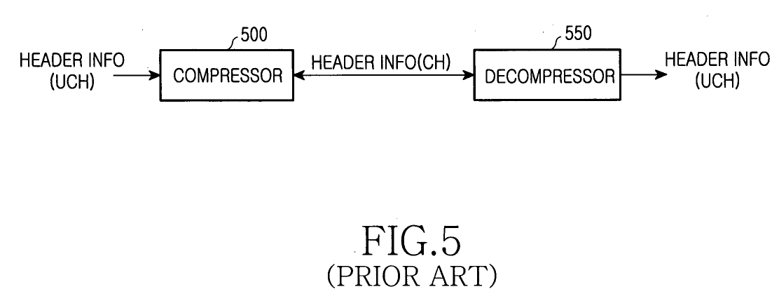

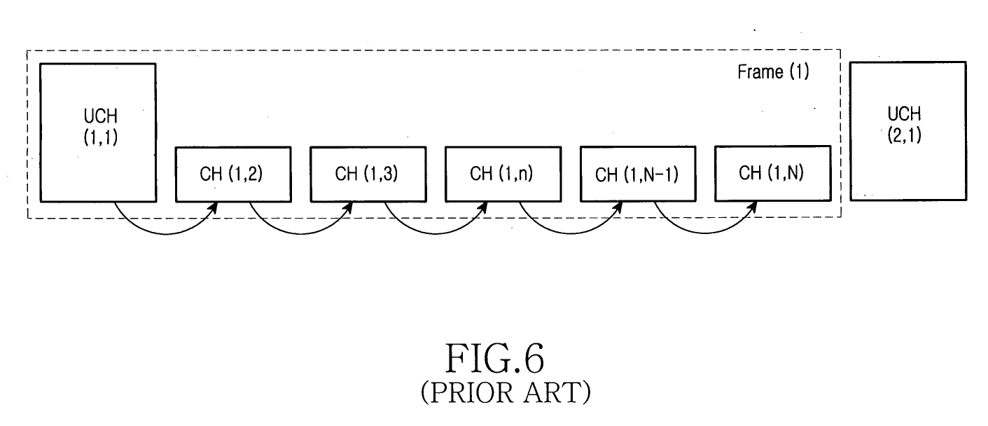

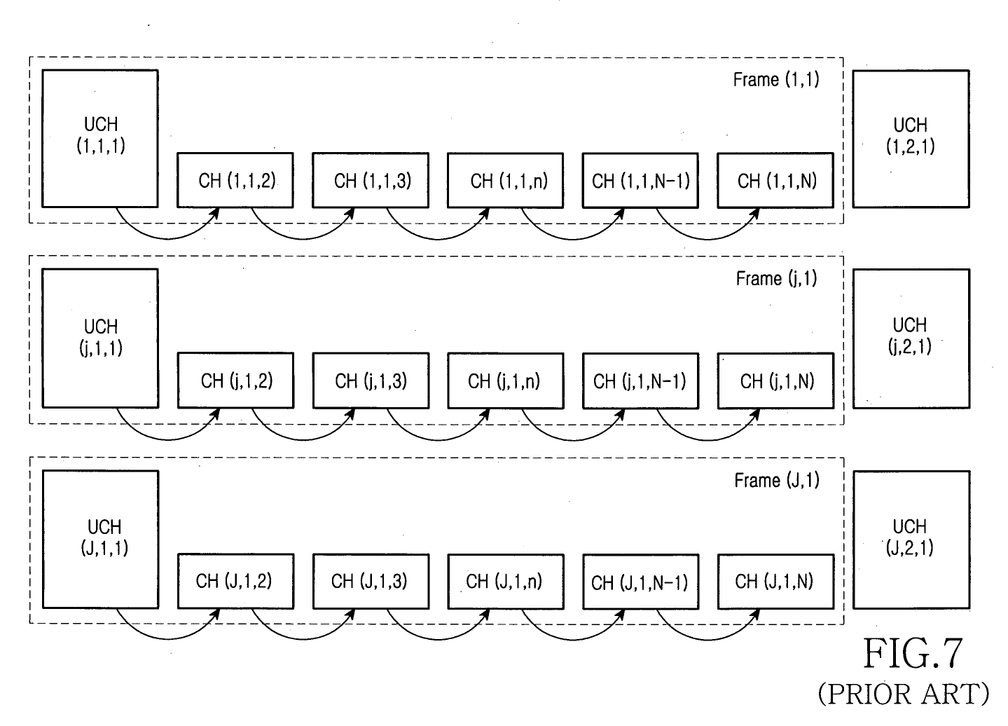

Before a description of FIG. 9 is given, it should be noted that as header information, i.e. UCH information, of the IP communication system includes redundancy information as described in the prior art section with reference to FIGS. 1 and 2, only the essential information except for the redundancy information is compressed and generated as CH information. In the first embodiment of the present invention, AICs corresponding to UCH information or CH information are transmitted through all of the parallel channels except for the channel through which the UCH information or CH information is transmitted. In the second embodiment of the present invention, AICs corresponding to UCH information or CH information are transmitted through specific channels selected by a transmitter and the channel over which the UCH information or CH information is transmitted.

Referring to FIG. 9, because the IP communication system has a multi-channel structure, UCH information for J channels, i.e. UCH information (1,1,1), UCH information (j,1,1) and UCH information (J,1,1), and AICs to be transmitted through the J channels are received.

A description will now be made of a scheme of generating AICs transmitted through the J channels.

When the scheme according to the first embodiment of the present invention is used as the header information compression scheme, AICs for UCH information or CH information transmitted through the J channels are transmitted through all of the parallel channels except for the channels over which the UCH information or CH information is transmitted. The AICs transmitted through the J channels are generated as AICs for UCH information or CH information of the parallel channels except for a corresponding channel.

When the scheme according to the second embodiment of the present invention is used as the header information compression scheme, AICs for UCH information or CH information transmitted through the J channels are transmitted through channels related to the channels over which the UCH information or CH information is transmitted. The AICs transmitted through the J channels are generated as AICs for UCH information or CH information of the channels related to a corresponding channel and not the corresponding channel itself.

It will be assumed in FIG. 9 that the AICs are generated using the scheme according to the first embodiment of the present invention. For simplicity, only a first channel among the J channels will be described.

During a first frame of the first channel, if UCH information (1,1,1) is received, variable information in the UCH information (1,1,1), i.e. CH information (1,1,2), CH information (1,1,3), CH information (1,1,n), CH information (1,1,N−1), and CH information (1,1,N), are transmitted. That is, for N time slots that make up the first frame of the first channel, the UCH information (1,1,1) is transmitted at a first time slot of the first frame, and the CH information (1,1,2), the CH information (1,1,3), the CH information (1,1,n), the CH information (1,1,N−1) and the CH information (1,1,N), all of which are expressed with only the variable information in the UCH information (1,1,1), are transmitted at the remaining (N−1) time slots. In the UCH information (j,i,n), the CH information (j,i,n) and AIC (j,i,n), ‘j’ denotes a channel index, ‘i’ denotes a frame index and ‘n’ denotes a time slot index. The UCH information (j,i,n) represents UCH information at an n^{th} time slot in an i^{th} frame of a j^{th} channel, the CH information (j,i,n) represents CH information at an n^{th} time slot in an i^{th} frame of a j^{th} channel, and an AIC (j,i,n) represents an AIC at an n^{th} time slot in an i^{th} frame of a j^{th} channel. The UCH information (1,1,1), the CH information (1,1,2), the CH information (1,1,3), the CH information (1,1,n), the CH information (1,1,N−1) and the CH information (1,1,N) are transmitted together with an AIC (1,1,1), an AIC (1,1,2) generated by adding AICs generated by encoding CH information of the other channels except for the first channel, i.e. CH information (j,1,2) and CH information (J,1,2), with a encoding scheme, an AIC (1,1,3) generated by adding AICs generated by encoding CH information (j,1,3) and CH information (J,1,3) with the encoding scheme, an AIC (1,1,n) generated by adding AICs generated by encoding CH information (j,1,n) and CH information (J,1,n) with the encoding scheme, an AIC (1,1,N−1) generated by adding AICs generated by encoding CH information (j,1,N−1) and CH information (J,1,N−1) with the encoding scheme, and an AIC (1,1,N) generated by adding AICs generated by encoding CH information (j,1,N) and CH information (J,1,N) with the encoding scheme. The AIC (1,1,1) has the same value as that of an AIC for a CH in a UCH of another channel. Although a CH is not transmitted and a UCH is transmitted at a corresponding time slot, a rule regarding how the CH is generated from the UCH is predefined. Although a transmitter does not directly transmit the CH, it combines the CH, generates an AIC for it, i.e. an AIC (1,1,1), and transmits it together with the UCH.

In FIG. 9, the final CH information transmitted through the J channels includes CH information for the J channels, and information generated by concatenating AICs of the other parallel channels except for a corresponding channel for each of the J channels.

Because UCH information and CH information are transmitted together with AICs as described with reference to FIG. 9, the reliability of the header information can be increased. However, the overhead for the case where the AICs are transmitted together is slightly greater than the overhead for the case when only the CHs are transmitted, although it is less than a header size in the IP communication system in which no header compression scheme is used. A scheme of encoding the AICs serves as a very important factor in terms of the overhead. That is, in terms of the overhead, it is very important to make the overhead of the AICs be less than overhead of the CH information and overhead of the UCH information, and to minimize the overhead of the AICs. The present invention will use an encoding scheme designed to minimize the overhead of the AICs, and a detailed description of the encoding scheme will be omitted herein because it is not directly related to the present invention. Because the minimization of the overhead of the AICs may increase a packet error probability (PEP), it is necessary to weight either the AIC overhead or the PEP, according to conditions of the IP communication system. Tradeoffs between weighting the AIC overhead and the PEP is not directly related to the present invention, so a detailed description thereof will be omitted herein.

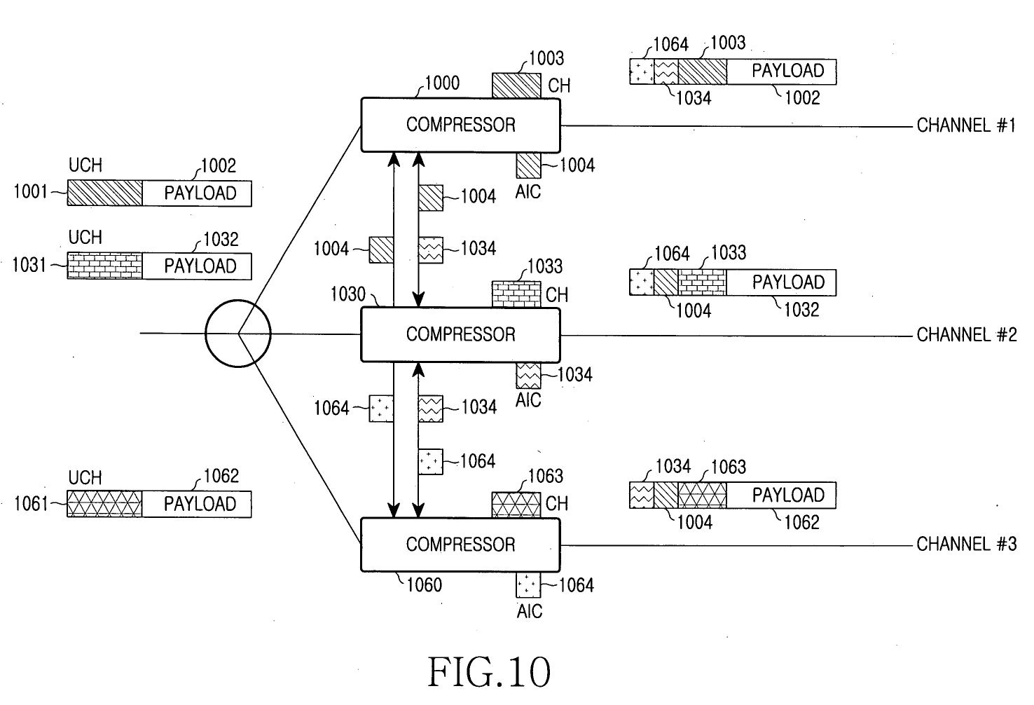

FIG. 10 is a diagram illustrating a structure of a header information compressor for compressing header information using a mode-A scheme in a transmitter for an IP communication system with a multi-channel structure according to a first embodiment of the present invention.

It will be assumed that the IP communication system uses 3 channels of a channel #1, a channel #2 and a channel #3. Referring to FIG. 10, if user data for the 3 channels is received, each of the user data is delivered to its corresponding compressor 1000, 1030 or 1060 for the 3 channels. Each of the user data is comprised of UCH information and a payload.

First, a header information compression operation for the channel #1 will be described.

If user data comprised of UCH information 1001 and a payload 1002 is received, the compressor 1000 generates CH information 1003 by compressing the UCH information 1001, and also generates an AIC 1004. The compressor 1000 generates the AIC 1004 by encoding the CH information 1003 with a predetermined encoding scheme.

A deliverer (not shown) delivers the AIC 1004 to the other channels except for the channel #1, i.e. the channel #2 and the channel #3. The deliverer performs an operation of delivering AICs generated by the compressor 1000 for the channel #1, the compressor 1030 for the channel #2 and the compressor 1060 for the channel #3 to the other channels except for the corresponding channels, for each of the channels used by a transmitter for the IP communication system. An operation in each of the channels for the deliverer will be described in detail later along with a description of a header information compression operation for each of the channels.

The compressor 1000 receives, from the deliverer, AICs for the other channels except for the channel #1, i.e. an AIC 1034 generated by the compressor 1030 for the channel #2 and an AIC 1064 generated by the compressor 1060 for the channel #3, and generates final CH information by concatenating the CH information 1003, the AIC 1034, and the AIC 1064.

Second, a header information compression operation for the channel #2 will be described.

If user data comprised of UCH information 1031 and a payload 1032 is received, the compressor 1030 generates CH information 1033 by compressing the UCH information 1031, and also generates the AIC 1034. The compressor 1030 generates the AIC 1034 by encoding the CH information 1033 with the encoding scheme. The deliverer delivers the AIC 1034 to the other channels except for the channel #2, i.e. the channel #1 and the channel #3.

The compressor 1030 receives, from the deliverer, AICs for the other channels except for the channel #2, i.e. the AIC 1004 generated by the compressor 1000 for the channel #1 and the AIC 1064 generated by the compressor 1060 for the channel #3, and generates final CH information by concatenating the CH information 1033, the AIC 1004, and the AIC 1064.

Third, a header information compression operation for the channel #3 will be described.

If user data comprised of UCH information 1061 and a payload 1062 is received, the compressor 1060 generates CH information 1063 by compressing the UCH information 1061, and also generates the AIC 1064. The compressor 1060 generates the AIC 1064 by encoding the CH information 1063 with the encoding scheme. The deliverer delivers the AIC 1064 to the other channels except for the channel #3, i.e. the channel #1 and the channel #2.

The compressor 1060 receives, from the deliverer, AICs for the other channels except for the channel #3, i.e. the AIC 1004 generated by the compressor 1000 for the channel #1 and the AIC 1034 generated by the compressor 1030 for the channel #2, and generates final CH information by concatenating the CH information 1063, the AIC 1004, and the AIC 1034. Although not separately illustrated in FIG. 10, the header information compressed by the compressors 1000, 1030 and 1060 is transmitted to a receiver via a transmitter.

As described with reference to FIG. 10, in the mode-A scheme, an AIC for a corresponding channel among the J channels is generated by a compressor for the corresponding channel and then delivered to all of the parallel channels except for the corresponding channel. Because the compressor for the corresponding channel generates the AIC for the corresponding channel, the amount of data, i.e. the number of AICs, to be delivered to all of the parallel channels except for the corresponding channel can be minimized.

Although an exemplary method for compressing header information using the mode-A scheme in a transmitter for an IP communication system with a multi-channel structure according to the first embodiment of the present invention has been described with reference to FIG. 10, the mode-A scheme can be used not only for the first embodiment of the present invention but also for the second embodiment of the present invention.

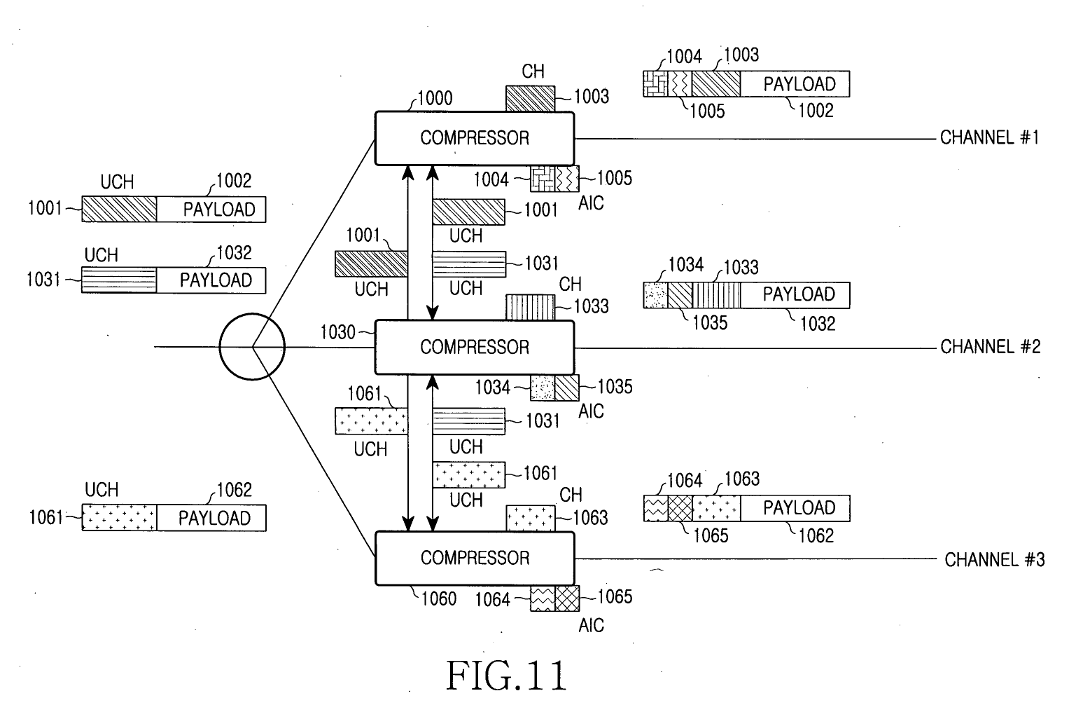

FIG. 11 is a diagram illustrating a structure of a header information compressor for compressing header information using a mode-B scheme in a transmitter for an IP communication system with a multi-channel structure according to the first embodiment of the present invention.

It will be assumed that the IP communication system uses 3 channels of a channel #1, a channel #2 and a channel #3. Referring to FIG. 11, if user data for the 3 channels is received, each of the user data is delivered to its corresponding compressor 1000, 1030 or 1060 for the 3 channels. Each of the user data is comprised of UCH information and a payload.

First, a header information compression operation for the channel #1 will be described.

If user data comprised of UCH information 1001 and a payload 1002 is received, the compressor 1000 generates CH information 1003 by compressing the UCH information 1001. A deliverer (not shown) delivers UCH information for the other channels except for the channel #1, i.e. UCH information 1031 for the channel #2 and UCH information 1061 for the channel #3, to the compressor 1000. The deliverer performs an operation of delivering UCH information for the other channels except for the corresponding channel to compressors for all of the channels used by a transmitter for the IP communication system, i.e. the compressor 1000 for the channel #1, the compressor 1030 for the channel #2, and the compressor 1060 for the channel #3. An operation in each of the channels for the deliverer will be described in detail later along with a description of a header information compression operation for each of the channels.

The compressor 1000 generates an AIC 1004 and an AIC 1005 by encoding the UCH information 1031 for the channel #2 and the UCH information 1061 for the channel #3 with a predetermined encoding scheme. The compressor 1000 generates final CH information by concatenating the CH information 1003, the AIC 1004 and the AIC 1005.

Second, a header information compression operation for the channel #2 will be described.

If user data comprised of UCH information 1031 and a payload 1032 is received, the compressor 1030 generates CH information 1033 by compressing the UCH information 1031. The deliverer delivers UCH information for the other channels except for the channel #2, i.e. UCH information 1001 for the channel #1 and UCH information 1061 for the channel #3, to the compressor 1030.

The compressor 1030 generates an AIC 1034 and an AIC 1035 by encoding the UCH information 1001 for the channel #1 and the UCH information 1061 for the channel #3 with the encoding scheme. The compressor 1030 generates final CH information by concatenating the CH information 1033, the AIC 1034 and the AIC 1035.

Third, a header information compression operation for the channel #3 will be described.

If user data comprised of UCH information 1061 and a payload 1062 is received, the compressor 1060 generates CH information 1063 by compressing the UCH information 1061. The deliverer delivers UCH information for the other channels except for the channel #3, i.e. UCH information 1001 for the channel #1 and UCH information 1031 for the channel #2, to the compressor 1060.

The compressor 1060 generates an AIC 1064 and an AIC 1065 by encoding the UCH information 1001 for the channel #1 and the UCH information 1031 for the channel #2 with the encoding scheme. The compressor 1060 generates final CH information by concatenating the CH information 1063, the AIC 1064 and the AIC 1065.

As described with reference to FIG. 11, in the mode-B scheme, an AIC for a corresponding channel is directly generated by the compressors for the other channels except for the corresponding channel. That is, the compressors for the other channels except for the corresponding channel generate the AIC for the corresponding channel, thereby increasing operational flexibility thereof.

Although an exemplary method for compressing header information using the mode-B scheme in a transmitter for an IP communication system with a multi-channel structure according to the first embodiment of the present invention has been described with reference to FIG. 11, the mode-B scheme can be used not only for the first embodiment of the present invention but also for the second embodiment of the present invention.

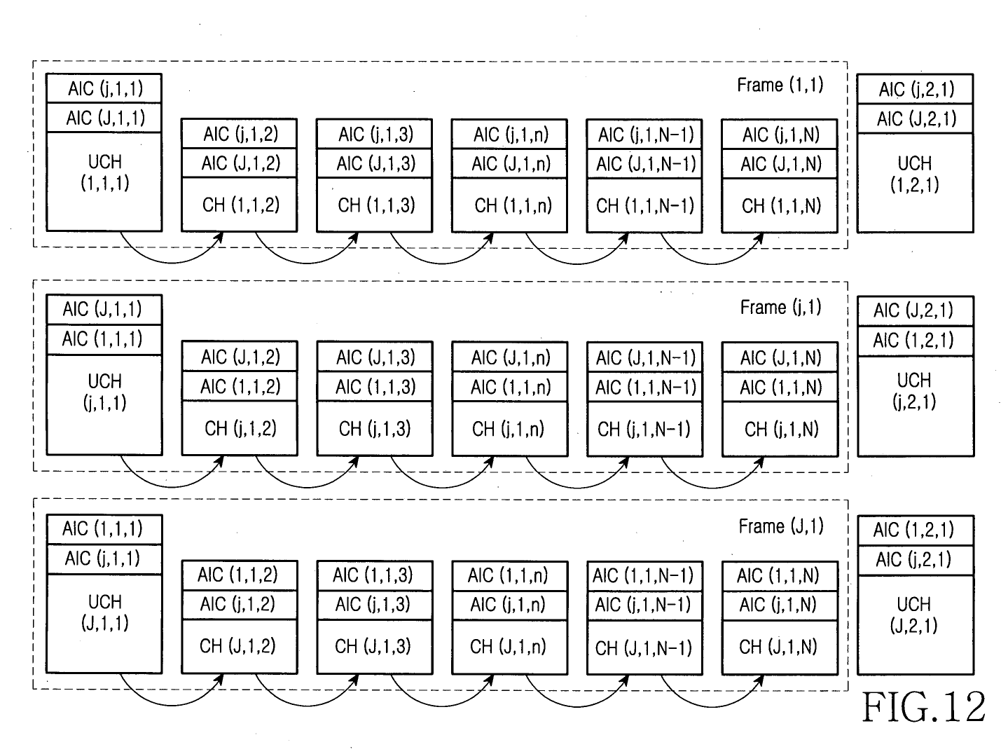

FIG. 12 is a diagram illustrating a header information compression scheme in an IP communication system with a multi-channel structure according to the first embodiment of the present invention.

It will be assumed that the IP communication system has a multi-channel structure in which J channels are used. Referring to FIG. 12, because the IP communication system has a multi-channel structure, UCH information for each of the J channels, i.e. UCH information (1,1,1), UCH information (j,1,1), UCH information (J,1,1), and AICs for the J channels are received. The AIC for each of the J channels is copied and then transmitted through all of the other channels except for the channel over which the corresponding AIC is transmitted.

Herein, only a first channel among the J channels will be described for simplicity. During a first frame of the first channel, if the UCH information (1,1,1) is received, variable information in the UCH information (1,1,1), i.e. CH information (1,1,2), CH information (1, 1,3), CH information (1,1,n), CH information (1,1,N−1), and CH information (1,1,N), are transmitted. That is, for N time slots that make up the first frame of the first channel, the UCH information (1,1,1) is transmitted at a first time slot of the first frame, and the CH information (1,1,2), the CH information (1,1,3), the CH information (1,1,n), the CH information (1,1,N−1) and the CH information (1,1,N), all of which are expressed with only the variable information in the UCH information (1,1,1), are transmitted at the remaining (N−1) time slots.

The UCH information (1,1,1), CH information (1,1,2), CH information (1,1,3), CH information (1,1,n), CH information (1,1,N−1), and CH information (1,1,N) are transmitted together with their corresponding AICs. A detailed description thereof will be given below.

First, the UCH information (1,1,1) is transmitted together with an AIC (1,1,1).

Second, the CH information (1,1,2) is transmitted together with an AIC (j,1,2) generated by encoding the CH information of the other channels except for the first channel, i.e. CH information (j,1,2), with a predetermined encoding scheme, and an AIC (J,1,2) generated by encoding CH information (J,1,2) with the encoding scheme.

Third, the CH information (1,1,3) is transmitted together with an AIC (j,1,3) generated by encoding the CH information of the other channels except for the first channel, i.e. CH information (j,1,3), with the encoding scheme, and an AIC (J,1,3) generated by encoding CH information (J,1,3) with the encoding scheme.

Fourth, the CH information (1,1,n) is transmitted together with an AIC (j,1,n) generated by encoding the CH information of the other channels except for the first channel, i.e. CH information (j,1,n), with the encoding scheme, and an AIC (J,1,n) generated by encoding CH information (J,1,n) with the encoding scheme.

Fifth, the CH information (1,1,N−1) is transmitted together with an AIC (J,1,N−1) generated by encoding the CH information of the other channels except for the first channel, i.e. CH information (j,1,N−1), with the encoding scheme, and an AIC (J,1,N−1) generated by encoding CH information (J,1,N−1) with the encoding scheme.

Sixth, the CH information (1,1,N) is transmitted together with an AIC (j,1,N) generated by encoding the CH information of the other channels except for the first channel, i.e. CH information (j,1,N), with the encoding scheme, and an AIC (J,1,N) generated by encoding CH information (J,1,N) with the encoding scheme.

Although the header information compression scheme according to the first embodiment of the present invention in which the mode-A scheme is used has been described with reference to FIG. 12, the mode-B scheme can also be used in the first embodiment of the present invention.

FIG. 13 is a diagram illustrating an operation of the header information compression scheme of FIG. 12 in case of errors.

Referring to FIG. 13, it will be assumed that errors have occurred in a 3^{rd} time slot and an n^{th} time slot of a first frame of a first channel, i.e. Frame(1,1), a 3^{rd} time slot of a first frame of a j^{th} channel, i.e. Frame(j,1), and an n^{th} time slot of a first frame of a J^{th} channel, i.e. Frame(J,1). CH information on the defective time slots, i.e. CH information (1,1,3), CH information (1,1,n), CH information (j,1,3), and CH information (J,1,n) cannot be normally restored.

In the first embodiment of the present invention, because an AIC for a corresponding channel is copied and then transmitted through the other channels except for the corresponding channel, AICs for the CH information (1,1,3) and the CH information (1,1,n), i.e. an AIC (1,1,3) and an AIC (1,1,n), are transmitted even through 3^{rd} time slots and n^{th} time slots of the j^{th} channel and the J^{th} channel, an AIC (j,1,3) for the CH information (j,1,3) is transmitted through 3^{rd} time slots of the first channel and the J^{th} channel, and an AIC (J,1,n) for the CH information (J,1,n) is transmitted through n^{th} time slots of the first channel and the j^{th} channel.

The CH information (1,1,3) can be restored with the AICs (1,1,3) transmitted through the 3^{rd} time slots of the j^{th} channel and the J^{th} channel, and the CH information (1,1,n) can be restored with the AICs (1,1,n) transmitted through the n^{th} time slots of the j^{th} channel and the J^{th} channel. However, because an error has occurred even in the 3^{rd} time slot of the j^{th} channel, the CH information (1,1,3) can be restored with the AIC (1,1,3) transmitted through the 3^{rd} time slot of the J^{th} channel. Similarly, because an error has occurred even in the n^{th} time slot of the J^{th} channel, the CH information (1,1,n) can be restored with the AIC (1,1,n) transmitted through the n^{th} time slot of the j^{th} channel.

The CH information (j,1,3) can be restored with AICs (j,1,3) transmitted through the 3^{rd} time slots of the first channel and the J^{th} channel. However, because an error has occurred even in the 3^{rd} time slot of the first channel, the CH information (j,1,3) can be restored with the AIC (j,1,3) transmitted through the 3^{rd} time slot of the J^{th} channel.

The CH information (J,1,n) can be restored with AICs (J,1,n) transmitted through the n^{th} time slots of the first channel and the j^{th} channel. However, because an error has occurred even in the n^{th} time slot of the first channel, the CH information (J,1,n) can be restored with the AIC (J,1,n) transmitted through the n^{th} time slot of the j^{th} channel.

As described with reference to FIG. 13, the first embodiment of the present invention copies an AIC for a corresponding channel and transmits the copied AICs through all of the other channels except for the corresponding channel, so that the header information can be normally restored even though an error has occurred in the corresponding channel.

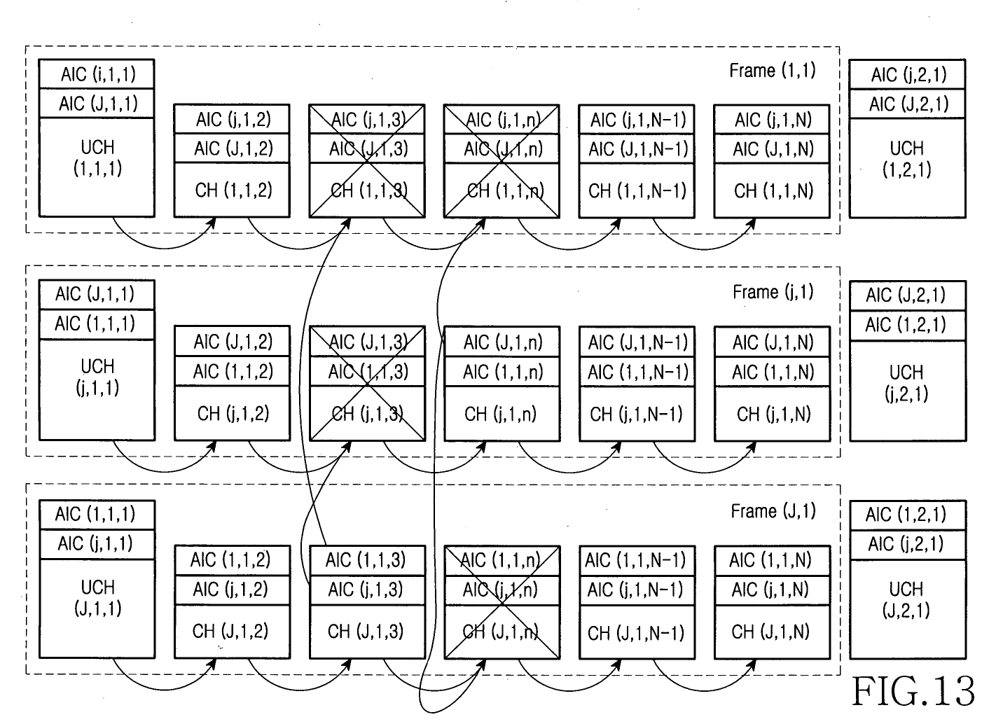

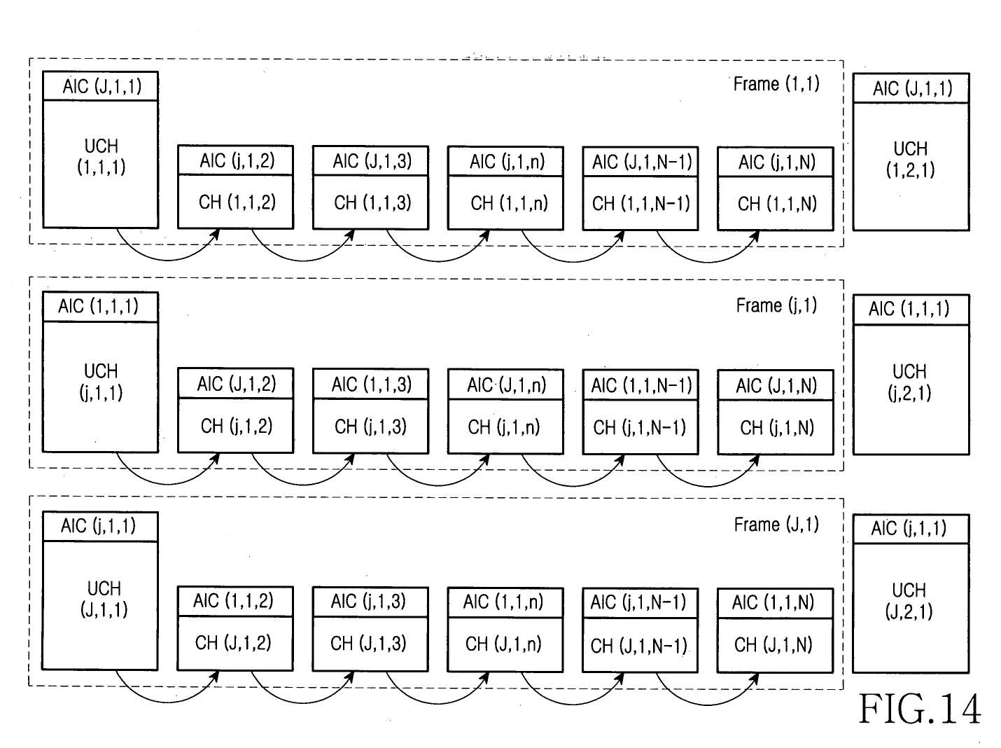

FIG. 14 is a diagram illustrating a header information compression scheme in an IP communication system with a multi-channel structure according to a second embodiment of the present invention.

It will be assumed that the IP communication system has a multi-channel structure in which J channels are used and the mode-A scheme is used. Referring to FIG. 14, because the IP communication system has a multi-channel structure, UCH information for each of the J channels, i.e. UCH information (1,1,1), UCH information (j,1,1), UCH information (J,1,1), and AICs for the J channels are received. The AIC for each of the J channels is copied and then transmitted through only the channels related to the channel over which the corresponding AIC is transmitted. A description will now be made of UCH information, CH information and AICs, transmitted through the channels.

(1) First Channel

During a first frame of the first channel, if the UCH information (1,1,1) is received, variable information in the UCH information (1,1,1), i.e. CH information (1,1,2), CH information (1,1,3), CH information (1,1,n), CH information (1,1,N−1), and CH information (1,1,N), are transmitted. That is, for N time slots that make up the first frame of the first channel, the UCH information (1,1,1) is transmitted at a first time slot of the first frame, and the CH information (1,1,2), the CH information (1,1,3), the CH information (1,1,n), the CH information (1,1,N−1) and the CH information (1,1,N), all of which are expressed with only the variable information in the UCH information (1,1,1), are transmitted at the remaining (N−1) time slots.

A description will now be made of a method of transmitting the UCH information (1,1,1), the CH information (1,1,2), the CH information (1,1,3), the CH information (1,1,n), the CH information (1,1,N−1), and the CH information (1,1,N) along with their corresponding AICs.

First, the UCH information (1,1,1) is transmitted together with an AIC (J,1,1).

Second, the CH information (1,1,2) is transmitted together with an AIC (j,1,2) generated by encoding the CH information (j,1,2) of the j^{th} channel with a predetermined encoding scheme.

Third, the CH information (1,1,3) is transmitted together with an AIC (J,1,3) generated by encoding the CH information (J,1,3) of the J^{th} channel with the encoding scheme.

Fourth, the CH information (1,1,n) is transmitted together with an AIC (J,1,n) generated by encoding the CH information (j,1,n) of the j^{th} channel with the encoding scheme.

Fifth, the CH information (1,1N−1) is transmitted together with an AIC (J, 1,N−1) generated by encoding the CH information (J,1,N−1) of the J^{th} channel with the encoding scheme.

Sixth, the CH information (1,1,N) is transmitted together with an AIC (j,1,N) generated by encoding the CH information (j,1,N) of the j^{th} channel with the encoding scheme.

(2) j^{th} Channel During a first frame of the j^{th} channel, if the UCH information (j,1,1) is received, variable information in the UCH information (j,1,1), i.e., CH information (j,1,2), CH information (j,1,3), CH information (j,1,n), CH information (j,1,N−1), and CH information (j,1,N), are transmitted. That is, for N time slots that make up the first frame of the j^{th} channel, the UCH information (j,1,1) is transmitted at a first time slot of the j^{th} frame, and the CH information (j,1,2), the CH information (j,1,3), the CH information (j,1,n), the CH information (j,1,N−1) and the CH information (j,1,N), all of which are expressed with only the variable information in the UCH information (j,1,1), are transmitted at the remaining (N−1) time slots.

A description will now be made of a method of transmitting the UCH information (j,1,1), the CH information (j,1,2), the CH information (j,1,3), the CH information (j,1, n), the CH information (j,1,N−1), and the CH information (j,1,N) along with their corresponding AICs.

First, the UCH information (j,1,1) is transmitted together with an AIC (1,1,1).

Second, the CH information (j,1,2) is transmitted together with an AIC (J,1,2) generated by encoding the CH information (J,1,2) of the j^{th} channel with the encoding scheme.

Third, the CH information (j,1,3) is transmitted together with an AIC (1,1,3) generated by encoding the CH information (1,1,3) of the first channel with the encoding scheme.

Fourth, the CH information (j,1,n) is transmitted together with an AIC (J,1,n) generated by encoding the CH information (J,1,n) of the J^{th} channel with the encoding scheme.

Fifth, the CH information (j,1,N−1) is transmitted together with an AIC (1,1,N−1) generated by encoding the CH information (1,1,N−1) of the first channel with the encoding scheme.

Sixth, the CH information (j,1,N) is transmitted together with an AIC (J,1,N) generated by encoding the CH information (J,1,N) of the J^{th} channel with the encoding scheme.

(3) J^{th} Channel

During a first frame of the J^{th} channel, if the UCH information (J,1,1) is received, variable information in the UCH information (J,1,1), i.e. CH information (J,1,2), CH information (J,1,3), CH information (J,1,n), CH information (J,1,N−1), and CH information (J,1,N), are transmitted. That is, for N time slots constituting the first frame of the J^{th} channel, the UCH information (J,1,1) is transmitted at a first time slot of the J^{th} frame, and the CH information (J,1,2), the CH information (J,1,3), the CH information (J,1,n), the CH information (J,1,N−1) and the CH information (J,1,N), all of which are expressed with only the variable information in the UCH information (J,1,1), are transmitted at the remaining (N−1) time slots.

A description will now be made of a method of transmitting the UCH information (J,1,1), the CH information (J,1,2), the CH information (J,1,3), the CH information (J,1,n), the CH information (J,1,N−1), and the CH information (J,1,N) along with their corresponding AICs.

First, the UCH information (J,1,1) is transmitted together with an AIC (j,1,1).

Second, the CH information (J,1,2) is transmitted together with an AIC (1,1,2) generated by encoding the CH information (1,1,2) of the first channel with the encoding scheme.

Third, the CH information (J,1,3) is transmitted together with an AIC (j,1,3) generated by encoding the CH information (j,1,3) of the j^{th} channel with the encoding scheme.

Fourth, the CH information (J,1,n) is transmitted together with an AIC (1,1,n) generated by encoding the CH information (1,1,n) of the first channel with the encoding scheme.

Fifth, the CH information (J,1,N−1) is transmitted together with an AIC (j,1,N−1) generated by encoding the CH information (j,1,N−1) of the j^{th} channel with the encoding scheme.

Sixth, the CH information (J,1,N) is transmitted together with an AIC (1,1,N) generated by encoding the CH information (1,1,N) of the first channel with the encoding scheme.

Although the header information compression scheme according to the second embodiment of the present invention in which the mode-A scheme is used has been described with reference to FIG. 14, the mode-B scheme can also be used in the second embodiment of the present invention.

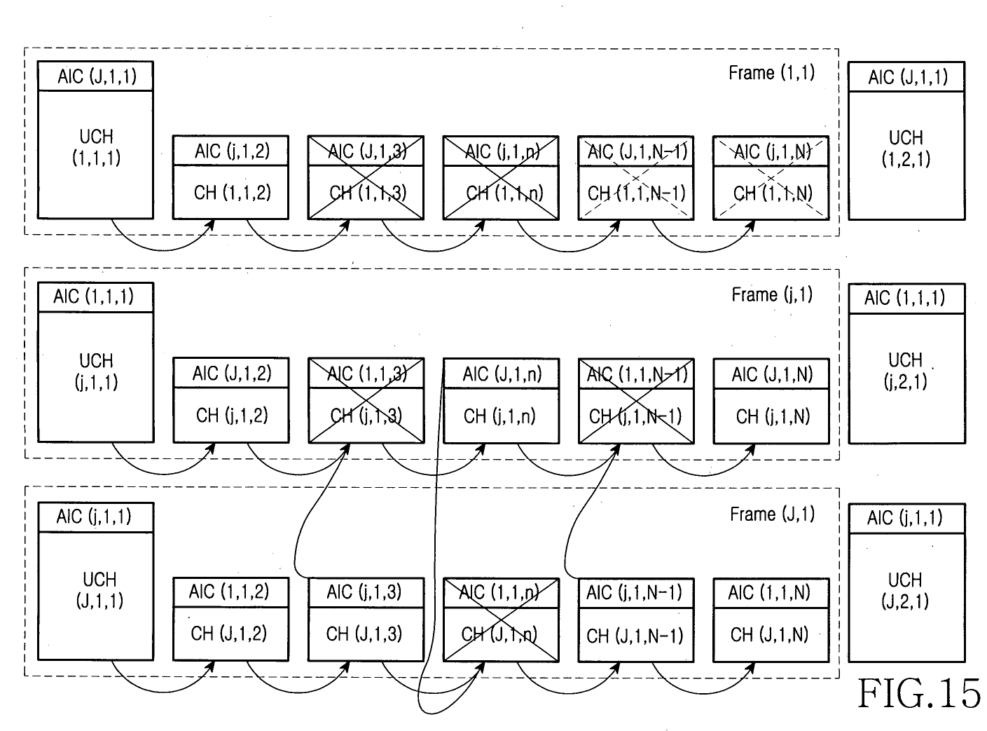

FIG. 15 is a diagram illustrating an operation of the header information compression scheme of FIG. 14 in case of errors.

Referring to FIG. 15, it will be assumed that errors have occurred in a 3^{rd} time slot and an n^{th} time slot of a first frame of a first channel, i.e. Frame(1,1), a 3^{rd} time slot and an (N−1)^{th} time slot of a first frame of a j^{th} channel, i.e. Frame(j,1), and an n^{th} time slot of a first frame of a J^{th} channel, i.e. Frame(J,1). CH information on the defective time slots, i.e. CH information (1,1,3), CH information (1,1,n), CH information (j,1,3), CH information (j,1,N−1), and CH information (J,1,n), cannot be normally restored.

In the second embodiment of the present invention, because an AIC for a corresponding channel is copied and then transmitted through only the channels related to the corresponding channel, an AIC (1,1,3) for the CH information (1,1,3) is transmitted even through a 3^{rd} time slot of the j^{th} channel, an AIC (1,1,n) for the CH information (1,1,n) is transmitted even through an n^{th} time slot of the J^{th} channel, an AIC (j,1,3) for the CH information (j,1,3) is transmitted even through a 3^{rd} time slot of the J^{th} channel, an AIC (j,1,N−1) for the CH information (j,1,N−1) is transmitted even through an (N−1)^{th} time slot of the J^{th} channel, and an AIC (J,1,n) for the CH information (J,1,n) is transmitted even through an n^{th} time slot of the j^{th} channel.

The CH information (1,1,3) can be restored with the AIC (1,1,3) transmitted through the 3^{rd} time slots of the j^{th} channel. However, because an error has occurred even in the 3^{rd} time slot of the j^{th} channel, the CH information (1,1,3) cannot be restored due to impossibility of using the AIC (1,1,3) transmitted through the 3^{rd} time slot of the j^{th} channel.

The CH information (1,1,n) can be restored with the AIC (1,1,n) transmitted through the n^{th} time slots of the J^{th} channel. However, because an error has occurred even in the n^{th} time slot of the J^{th} channel, the CH information (1,1,n) cannot be restored due to impossibility of using the AIC (1,1,n) transmitted through the n^{th} time slot of the J^{th} channel.

As described above, because the CH information (1,1,3) and the CH information (1,1,n) cannot be restored, the CH information (1,1,N−1) and the CH information (1,1,N) cannot be restored even though they are normally received.

The CH information (j,1,3) can be restored with the AIC (j,1,3) transmitted through the 3^{rd} time slot of the j^{th} channel. The CH information (j,1,N−1) can be restored with the AIC (j,1,N−1) transmitted through the (N−1)^{th} time slot of the J^{th} channel. In addition, the CH information (J,1,n) can be restored with the AIC (J,1,n) transmitted through the n^{th} time slot of the j^{th} channel.

As described with reference to FIG. 15, the second embodiment of the present invention transmits an AIC of a corresponding channel through only the channels related to the corresponding channel, thereby minimizing the AC overhead.

Next, a description will be made of a comparison between performance of the delta coding scheme, which is the conventional header compression scheme, and performance of the header compression schemes according to the first and second embodiments of the present invention.

Performance of the delta coding scheme will first be described.

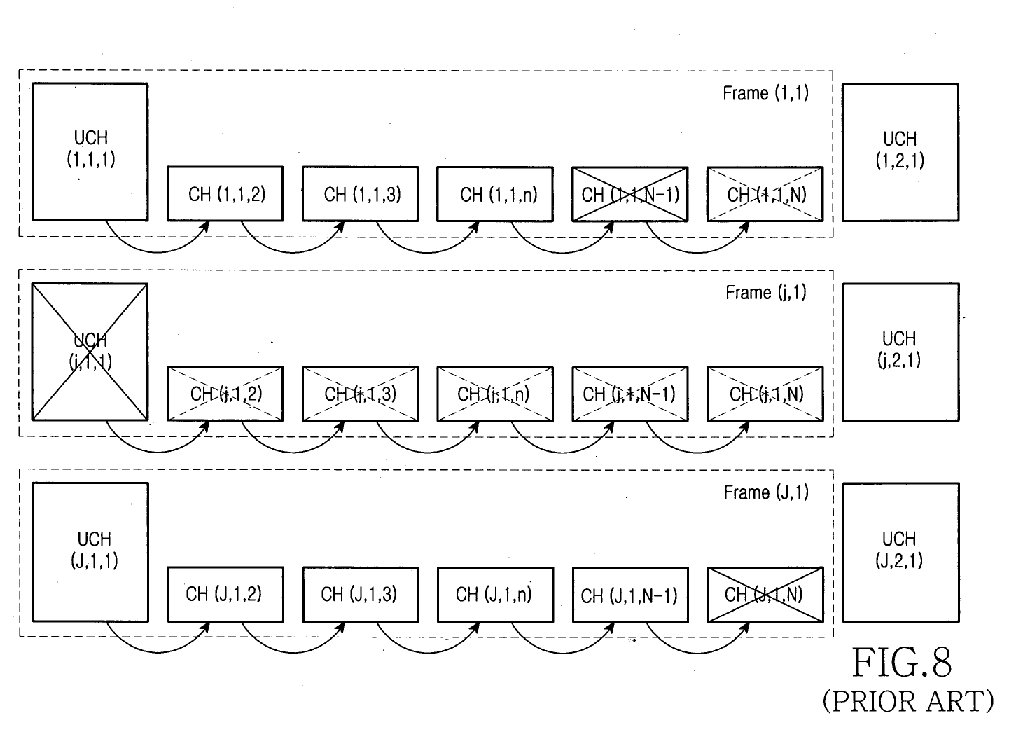

In the delta coding scheme used as the header compression scheme, as described in the prior art section with reference to FIG. 8, if an error occurs in a packet transmitted at one time slot in a frame, the defective packet, i.e. defective CH information, cannot be restored, making it impossible to restore the succeeding packets.

In order to calculate a PEP in the case of the delta coding scheme used as the header compression scheme, the probability that k packets could be lost should first be taken into consideration. The loss of k packets from a frame comprised of N packets indicates that (N−k) packets were normally received and a k^{th} packet was not normally received. Therefore, the last (k-1) packets cannot be restored even though they are normally received, defining a relationship shown below.
Pr(k packets are lost)=p(1−p)^{N-k} (1)

In Equation (1), ‘Pr(k packets are lost)’ denotes the probability that k packets among N packets will be lost, and ‘p’ denotes the probability that all of the N packets will be lost. Herein, the case where all of the N packets are lost corresponds to the case where a first packet, i.e. UCH information, among the N packets, is not normally received.

The average number of packets lost within one frame can be expressed as

$$Average = {\sum }_{k = 0}^{N} kPr ( k packets are lost ) \qquad ( 2 )$$

where ‘Average’ denotes the average number of lost packets among the N packets.

The PEP is calculated by dividing the average number ‘Average’ of lost packets among the N packets by the number N of the packets, as shown below.

$$PEP = \frac{Np + p ( 1 - p ) {\sum }_{k = 0}^{N} {k ( 1 - p )}^{N - k - 1}}{N} \qquad ( 3 )$$

Equation (3) can be rewritten as

$$PEP = 1 - \frac{( 1 - p ) ( 1 - {( 1 - p )}^{N} )}{Np} \qquad ( 4 )$$

The PEP shown in Equation (4) represents a PEP for the case where a single-channel structure is considered. Therefore, in the case where a multi-channel structure is considered, a receiver must multiply a payload of each packet by the number of packets normally received within one frame in order to estimate the amount of normally received packets (hereinafter referred to as “goodput”). It will be assumed herein that payloads of the packets are equal to each other in size. The goodput of the multi-channel structure can be defined as
G(goodput)=ND(1−PEP) (5)
where ‘D’ denotes a payload [byte].

The total overhead should be considered to estimate the total capacity of the IP communication system, and the total overhead can be expressed as
T(total overhead)=ND+Bᵤ+B_{c}(N−1) (6)
where ‘T’ denotes the total overhead, Bᵤ denotes overhead of UCH information, and B_{c} denotes overhead of CH information.

Therefore, performance of the delta coding scheme used as the header compression scheme can be written as

$$Efficiency = \frac{G}{T} = \frac{D ( 1 - p ) ( 1 - {( 1 - p )}^{N} )}{( 1 - p ) ( ND + {B}_{u} + {B}_{c} ( N - 1 ) )} \qquad ( 7 )$$

Next, a description will be made of performance of the scheme according to the first embodiment of the present invention used as the header compression scheme. The performance of the scheme according to the first embodiment of the present invention used as the header compression scheme will be described on the assumption that the mode-A scheme is used as an AIC encoding scheme.

In the case of the scheme according to the first embodiment of the present invention used as the header compression scheme, as described with reference to FIG. 13, even though an error has occurred in a packet transmitted through a particular channel among a plurality of channels, an AIC for the packet, i.e. CH information, is transmitted together on the other channels except for the channel over which the packet is transmitted. Therefore, the defective CH information can be restored.

In order to calculate a PEP in the case of the scheme according to the first embodiment of the present invention used as the header compression scheme, the probability that all of channels could be lost at the same time should be considered. This is because the scheme according to the first embodiment of the present invention can restore CH information as long as one packet on any channel is not lost.

For a particular channel, the loss probability of a k^{th} packet corresponds to the probability that the k^{th} packet will be lost due to a channel error or the k^{th} packet will be lost due to a propagation error, i.e. due to nonexistence of UCH information although there is no channel error. In the case of the scheme according to the first embodiment of the present invention used as the header compression scheme, the loss probability of a k^{th} packet can be defined as
Pr(k^{th} pakcet is lost)=p+(1−p)(p^{J}+(1−p^{J})p^{J}+ . . . +(1−p^{J})^{k-2}p^{J} (8)

In Equation (8), ‘Pr(k^{th} packet is lost)’ denotes the probability that a k^{th} packet will be lost, p^{J} denotes the probability that packets on all of the channels, i.e. J channels, could be lost at the same time, and J denotes the number of channels.

The average number of packets lost within one frame can be defined as

$$Average = {\sum }_{k = 0}^{N} kPr ( {k}^{th} packet is lost ) = pN + ( 1 - p ) {p}^{J} {\sum }_{k = 1}^{N - 1} {k ( 1 - {p}^{J} )}^{N - k - 1} \qquad ( 9 )$$

The PEP can be written as

$$PEP = 1 - \frac{( 1 - p ) ( 1 - {( 1 - {p}^{J} )}^{N} )}{{Np}^{J}} \qquad ( 10 )$$

In Equation (10), the number of channels J is assumed to be 8, and if the number of channels J increases to the infinite, the PEP converges on p. That is, an increase in the number of the channels J minimizes the propagation error.

Therefore, in the case of the scheme according to the first embodiment of the present invention used as the header compression scheme, there is no packet error caused by the propagation error, and thus, performance of the scheme according to the first embodiment of the present invention used as the header compression scheme can be expressed as

$$Efficiency = \frac{ND ( 1 - PEP )}{( ND + {B}_{u} + {B}_{c} ( N - 1 ) + N ( J - 1 ) {B}_{a} )} \qquad ( 11 )$$

where Bₐ denotes AIC overhead.

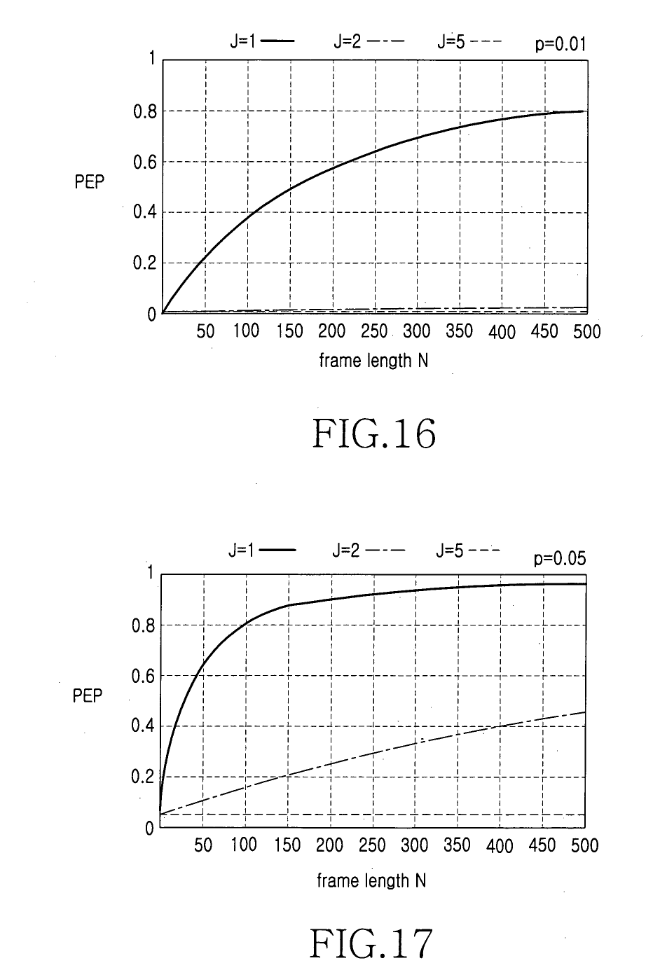

With reference to FIGS. 16 to 18, a description will now be made of a PEP with respect to a channel error probability and a frame length in the case of the scheme according to the first embodiment of the present invention used as the header compression scheme. Herein, the frame length refers to the number of packets constituting the frame.

FIG. 16 is a graph illustrating a PEP for a channel error probability equal to 1% in an IP communication system according to the first embodiment of the present invention.

It can be noted from FIG. 16 that for the channel error probability equal to 1% (p=0.01), an increase in the number of channels J used in the IP communication system dramatically reduces the PEP. In addition, it can be understood that a reduction in the frame length reduces the PEP.

FIG. 17 is a graph illustrating a PEP for a channel error probability equal to 5% in an IP communication system according to the first embodiment of the present invention.

It can be noted from FIG. 17 that for the channel error probability equal to 5% (p=0.05), an increase in the number of channels J used in the IP communication system dramatically reduces the PEP. In addition, it can be understood that a reduction in the frame length reduces the PEP, and in particular, the increase in the number of channels J is almost insignificant to a PEP effect with respect to the frame length.

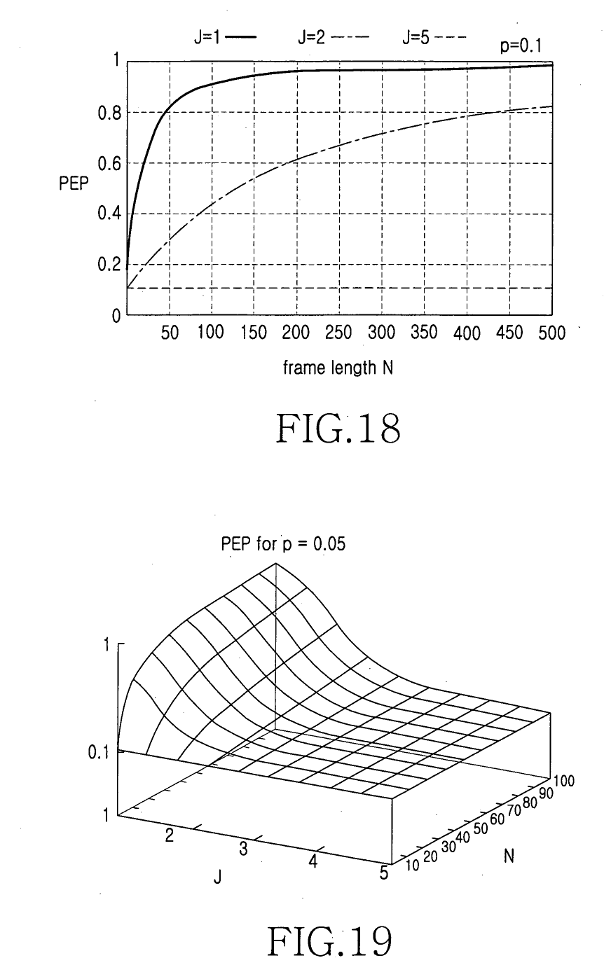

FIG. 18 is a graph illustrating a PEP for a channel error probability equal to 10% in an IP communication system according to the first embodiment of the present invention.

It can be noted from FIG. 18 that for the channel error probability equal to 10% (p=0.1), an increase in the number of channels J used in the IP communication system dramatically reduces the PEP. In addition, it can be understood that a reduction in the frame length reduces the PEP, and in particular, the increase in the number of channels J is almost insignificant to a PEP effect with respect to the frame length.

Next, a description will be made of efficiency with respect to a payload length in the case of the scheme according to the first embodiment of the present invention used as the header compression scheme.

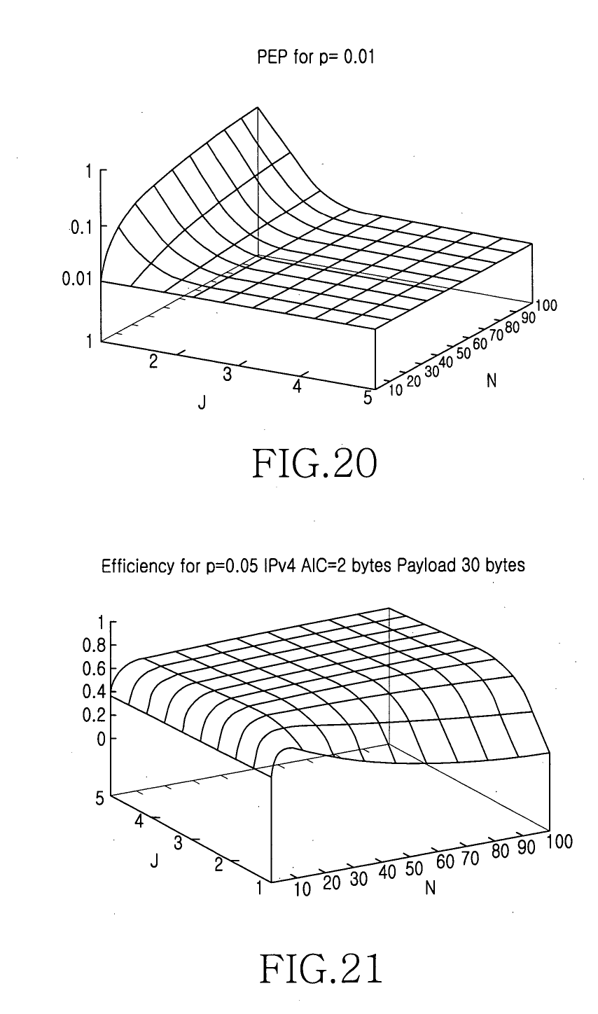

Assuming that the number of channels is J and a frame length is N for a description of the number of channels required for efficient and robust header compression, relationships between a PEP and the number of channels J and the frame length N are shown in FIG. 19 and FIG. 20.

FIG. 19 is a diagram illustrating a relationship between a PEP and the number of channels J and a frame length N for p=0.05 in an IP communication system according to the first embodiment of the present invention.

Referring to FIG. 19, if the number J of channels is greater than or equal to 3 (J≧3), the PEP is equal to the channel error probability (PEC) regardless of the frame length N. However, if the number of channels J is 1 (J=1), the PEP abruptly increases with the frame length N, resulting in performance degradation.

FIG. 20 is a diagram illustrating a relationship between a PEP and the number of channels J and a frame length N for p=0.01 in an IP communication system according to the first embodiment of the present invention.

Referring to FIG. 20, if the number of channels J is greater than or equal to 3 (J≧3), the PEP is equal to the PEC regardless of the frame length N. However, if the number of channels J is 1 (J=1), the PEP abruptly increases with the frame length N, resulting in performance degradation.

Next, with reference to FIGS. 21 to 24, a description will be made of a relationship between efficiency and the number J of channels and a frame length N in an IP communication system according to the first embodiment of the present invention.

FIG. 21 is a diagram illustrating a relationship between efficiency and the number of channels J and a frame length N for p=0.05 and a packet length of 30 bytes in an IP communication system according to the first embodiment of the present invention.

It can be noted from FIG. 21 that an increase in the number of channels J used in the IP communication system increases the efficiency. In particular, it can be understood from FIG. 21 that the efficiency is optimized when the number of channels J is greater than or equal to 3 (J≧3).

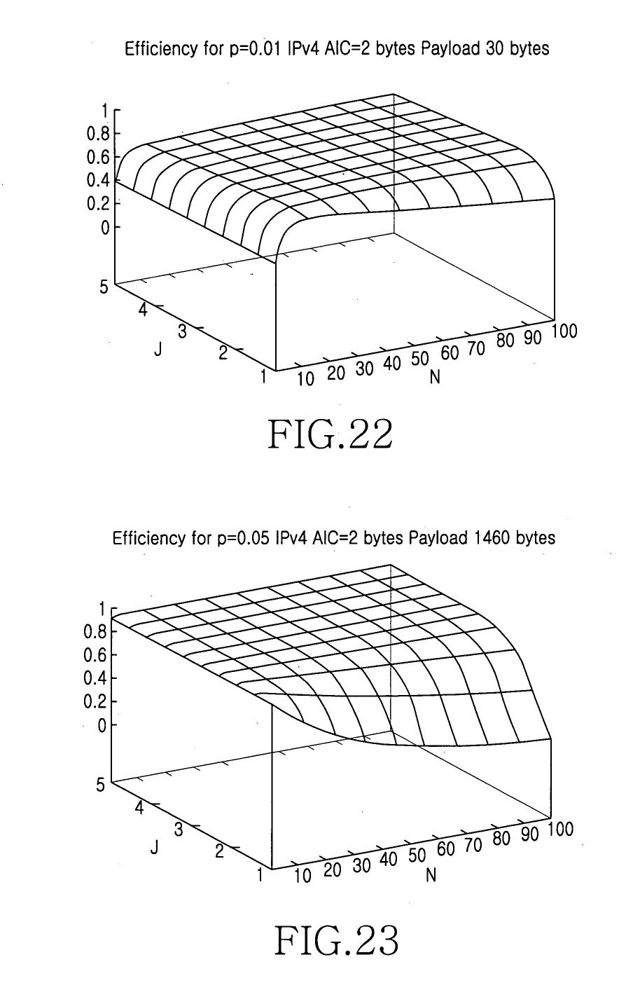

FIG. 22 is a diagram illustrating a relationship between efficiency and the number of channels J and a frame length N for p=0.01 and a packet length of 30 bytes in an IP communication system according to the first embodiment of the present invention.

It can be noted from FIG. 22 that an increase in the number of channels J used in the IP communication system increases the efficiency. In particular, it can be understood from FIG. 22 that the efficiency is optimized when the number of channels J is greater than or equal to 3 (J≧3).

FIG. 23 is a diagram illustrating a relationship between efficiency and the number of channels J and a frame length N for p=0.05 and a packet length of 1460 bytes in an IP communication system according to the first embodiment of the present invention.

It can be noted from FIG. 23 that an increase in the number of channels J used in the IP communication system increases the efficiency. In particular, it can be understood from FIG. 23 that the efficiency is optimized when the number of channels J is greater than or equal to 3(J≧3).

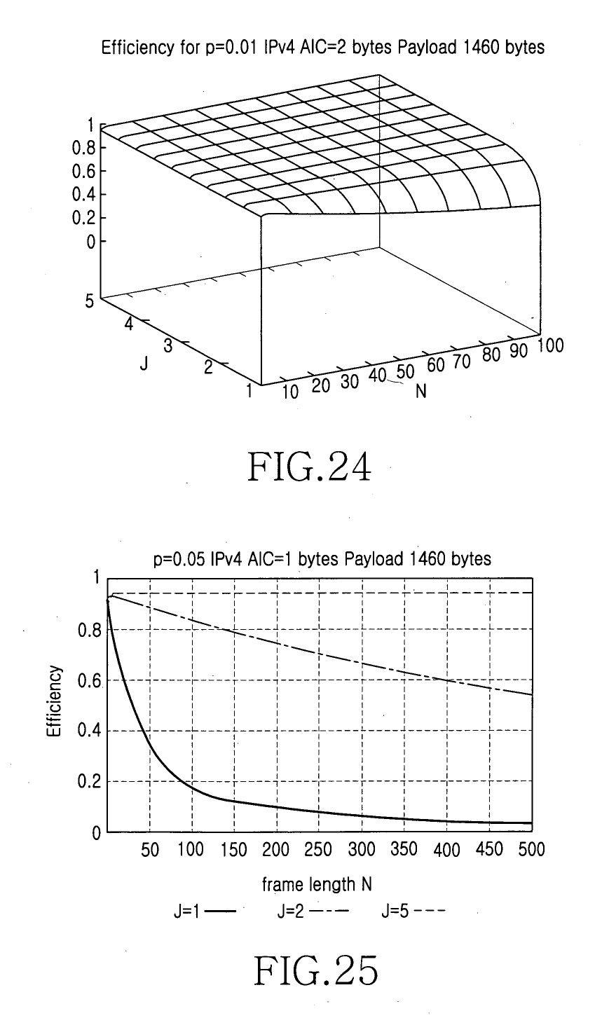

FIG. 24 is a diagram illustrating a relationship between efficiency and the number of channels J and a frame length N for p=0.01 and a packet length of 1460 bytes in an IP communication system according to the first embodiment of the present invention.

It can be noted from FIG. 24 that an increase in the number of channels J used in the IP communication system increases the efficiency. In particular, it can be understood from FIG. 24 that the efficiency is optimized when the number of channels J is greater than or equal to 3 (J≧3), and compared with the efficiency described with reference to FIG. 22, the efficiency increases with the packet length.

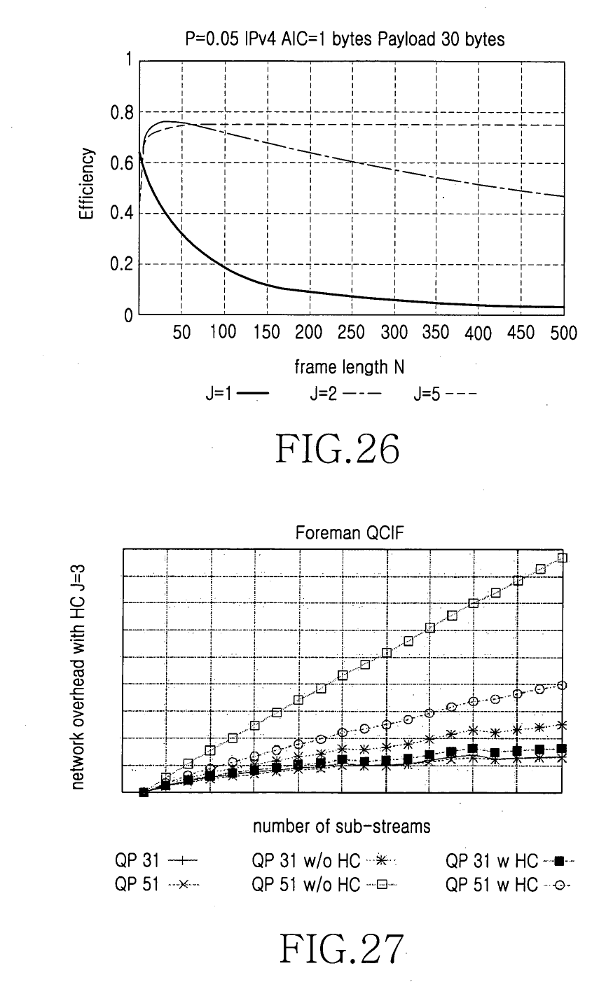

Next, with reference to FIGS. 25 and 26, a description will now be made of relationship between a payload length and efficiency in an IP communication system according to the first embodiment of the present invention.

FIG. 25 is a diagram illustrating efficiency for p=0.05 and a payload length of 1460 bytes in an IP communication system according to the first embodiment of the present invention.

It can be noted from FIG. 25 that an increase in the number of channels J used in the IP communication system increases the efficiency. In particular, it can be understood from FIG. 25 that the increase in the number of channels J increases the efficiency regardless of the number of the channels J.

FIG. 26 is a diagram illustrating efficiency for p=0.05 and a payload length of 30 bytes in an IP communication system according to the first embodiment of the present invention.

It can be noted from FIG. 26 that an increase in the number of channels J used in the IP communication system increases the efficiency. In particular, it can be understood from FIG. 26 that the increase in the number of channels J increases the efficiency regardless of the number of the channels J, and compared with the efficiency described with reference to FIG. 25, the efficiency increases with the payload length.

As a result, in the case of the scheme according to the first embodiment of the present invention used as the header compression scheme, an increase in the number of channels used in the IP communication system with a multi-channel structure ensures efficient and robust header compression.

FIG. 27 is a graph illustrating overhead of header information with respect to the number of sub-streams in an IP communication system in which the scheme according to the first embodiment of the present invention is used as the header compression scheme.

FIG. 27 shows a relationship between the number of sub-streams, i.e. descriptors, and overhead of header information, and also shows overhead of header information for the case where two quantized values of, for example, QP31 and QP51, are used. It is assumed that the sub-streams shown in FIG. 27 have a Foreman quarter common intermediate format (QCIF). In FIG. 27, ‘QP X’ represents encoding overhead for a quantization level X, and ‘QP X+N’ represents a sum of encoding overhead for the quantization level X and network overhead of the IPv4 communication system.

It can be noted from FIG. 27 that the overhead of header information abruptly increases by the network overhead rather than the quantization level, but the network overhead depends not on the IP overhead but on the encoding overhead.

The performance of the scheme according to the first embodiment of the present invention used as the header compression scheme has been described so far. Next, a description will be made of performance of the scheme according to the second embodiment of the present invention used as the header compression scheme. The performance of the scheme according to the second embodiment of the present invention used as the header compression scheme will be described on the assumption that the mode-A scheme is used as an AIC encoding scheme.

In the case of the scheme according to the second embodiment of the present invention used as the header compression scheme, as described with reference to FIG. 15, even though an error has occurred in a packet transmitted through a particular channel among a plurality of channels, an AIC for the packet, i.e. CH information, is transmitted together on the channels related to the channel over which the packet is transmitted. Therefore, the defective CH information can be restored.

In order to calculate a PEP in the case of the scheme according to the second embodiment of the present invention used as the header compression scheme, the following two conditions will be considered.

As a first condition, assuming that the number of channels used in the IP communication system is J, AICs of a particular channel are transmitted through m related channels among the J channels. As a second condition, to restore a k^{th} packet, i.e. k^{th} CH information, a (k-1)¹ packet, i.e. (k-1)^{th} CH information, transmitted in the same channel as the channel over which the k^{th} packet was transmitted, is used. Alternatively, to restore the k^{th} packet, it is also possible to use a k^{th} packet transmitted through the channels related to the channel over which the k^{th} packet was transmitted.

In this case, the PEP can be expressed as

$$PEP = 1 - \frac{( 1 - p ) ( 1 - {( 1 - {p}^{m + 1} )}^{N} )}{{Np}^{m + 1}} \qquad ( 12 )$$

Performance of the scheme according to the second embodiment of the present invention used as the header compression scheme can be written as

$$Efficiency = \frac{ND ( 1 - PEP )}{( ND + {B}_{u} + {B}_{c} ( N - 1 ) + {NmB}_{a} )} \qquad ( 13 )$$

When independent error patterns are considered, all of the performance analyses in the case of the scheme according to the second embodiment of the present invention used as the header compression scheme are equal to performance analyses in the case of the scheme according to the first embodiment of the present invention used as the header compression scheme, in which the number of channels J is set to (m+1). Therefore, performance analyses on the scheme according to the second embodiment of the present invention are achieved on the assumption that the number of channels J is (m+1), and the (m+1) channels include a channel over which a particular packet is transmitted and channels related to the channel over which the packet is transmitted. For convenience, the (m+1) channels will be referred to as “channels used for header compression.”

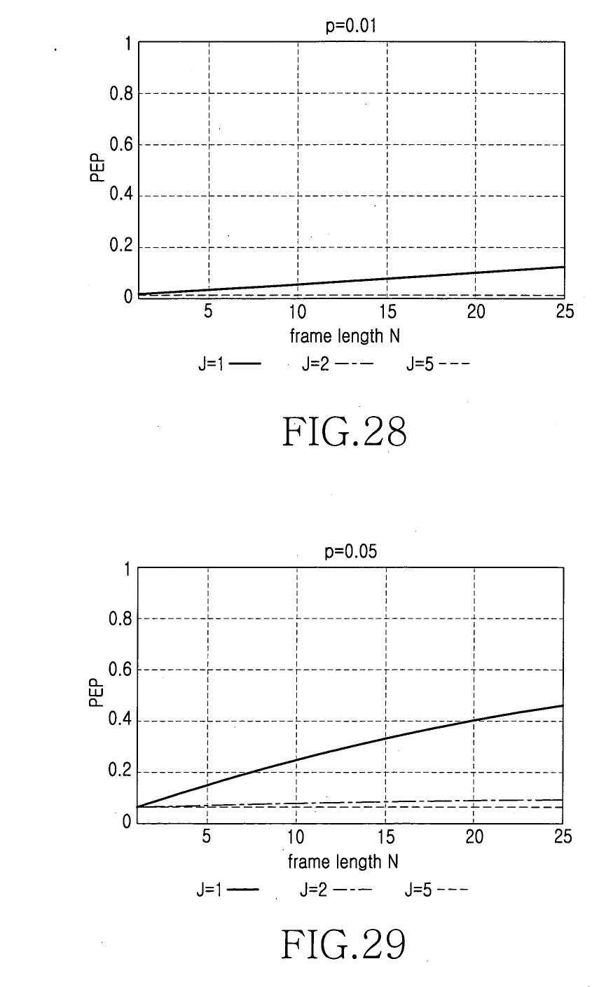

With reference to FIGS. 28 to 30, a description will now be made of a PEP with respect to a PEC and a frame length in the case of the scheme according to the second embodiment of the present invention used as the header compression scheme. Herein, the frame length refers to the number of packets constituting the frame.

FIG. 28 is a graph illustrating a PEP for a channel error probability equal to 1% in an IP communication system according to the second embodiment of the present invention.

It can be noted from FIG. 28 that for the channel error probability equal to 1% (p=0.01), an increase in the number of channels J used in the IP communication system dramatically reduces the PEP. In addition, it can be understood that a reduction in the frame length reduces the PEP.

FIG. 29 is a graph illustrating a PEP for a channel error probability equal to 5% in an IP communication system according to the second embodiment of the present invention.

It can be noted from FIG. 29 that for the channel error probability equal to 5% (p=0.05), an increase in the number of channels J used in the IP communication system dramatically reduces the PEP. In addition, it can be understood that a reduction in the frame length reduces the PEP, and in particular, the increase in the number of channels J is almost insignificant to a PEP effect with respect to the frame length.

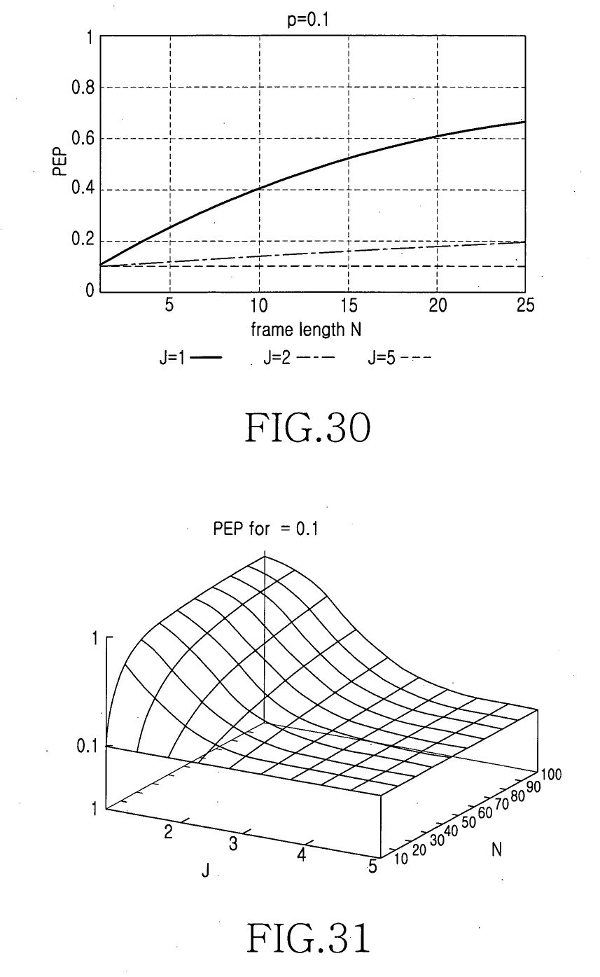

FIG. 30 is a graph illustrating a PEP for a channel error probability equal to 10% in an IP communication system according to the second embodiment of the present invention.

Assuming that the number of channels is J and a frame length is N for a description of the number of channels required for efficient and robust header compression, a relationship between a PEP and the number of channels J and the frame length N is shown in FIG. 31.

FIG. 31 is a diagram illustrating a relationship between a PEP and the number of channels J and a frame length N for p=0.1 in an IP communication system according to the second embodiment of the present invention.

Referring to FIG. 31, if the number of channels J is greater than or equal to 3 (J≧3), the PEP is equal to a PEC regardless of the frame length N. However, if the number of channels J is 1 (J=1), the PEP abruptly increases with the frame length N, resulting in performance degradation.

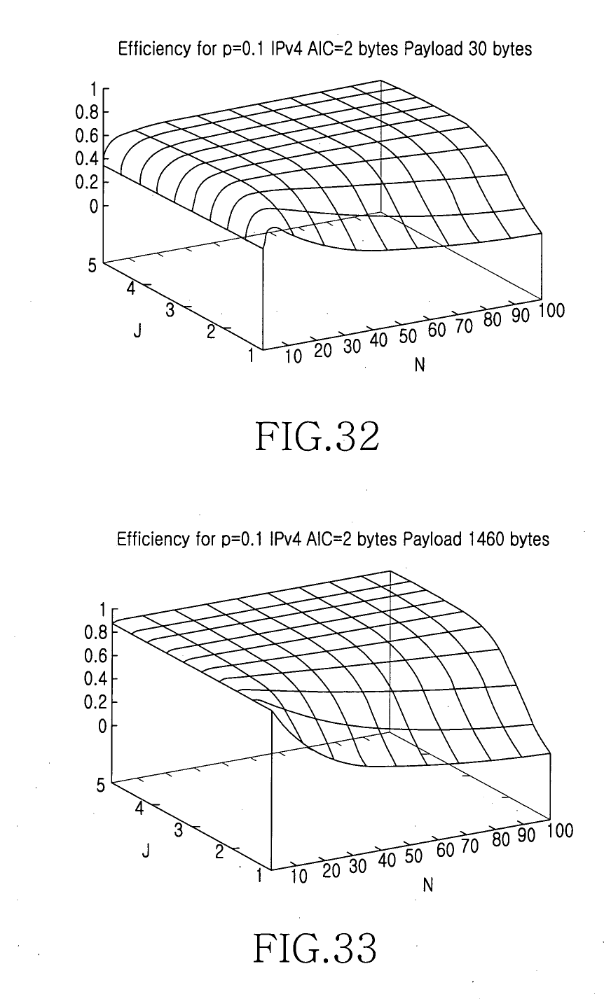

Next, with reference to FIGS. 32 and 33, a description will be made of a relationship between efficiency and the number of channels J and a frame length N in an IP communication system according to the second embodiment of the present invention.

FIG. 32 is a diagram illustrating a relationship between efficiency and the number of channels J and a frame length N for p=0.1 and a packet length of 30 bytes in an IP communication system according to the second embodiment of the present invention.

It can be noted from FIG. 32 that an increase in the number of channels J used in the IP communication system increases the efficiency. In particular, it can be understood from FIG. 32 that the efficiency is optimized when the number of channels J is greater than or equal to 3 (J≧3).

FIG. 33 is a diagram illustrating a relationship between efficiency and the number of channels J and a frame length N for p=0.1 and a packet length of 1460 bytes in an IP communication system according to the second embodiment of the present invention.

It can be noted from FIG. 33 that an increase in the number of channels J used in the IP communication system increases the efficiency. In particular, it can be understood from FIG. 33 that the efficiency is optimized when the number of channels J is greater than or equal to 3 (J≧3), and compared with the efficiency described with reference to FIG. 32, the efficiency increases with the packet length.

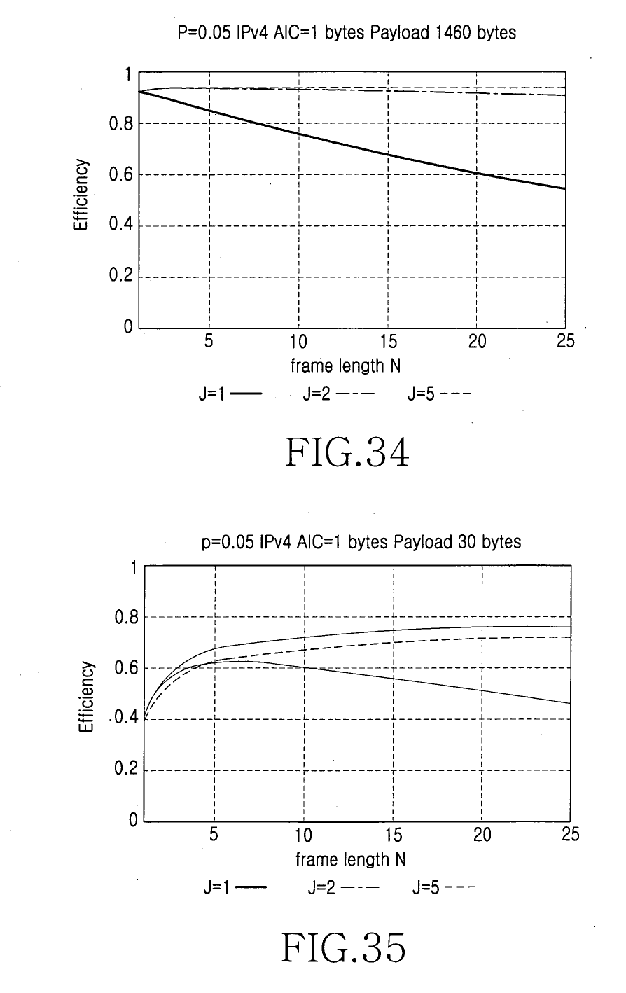

Next, with reference to FIGS. 34 and 35, a description will now be made of relationship between a payload length and efficiency in an IP communication system according to the second embodiment of the present invention.

FIG. 34 is a diagram illustrating efficiency for p=0.05 and a payload length of 1460 bytes in an IP communication system according to the second embodiment of the present invention.

It can be noted from FIG. 34 that an increase in the number of channels J used in the IP communication system increases the efficiency. In particular, it can be understood from FIG. 34 that the increase in the number of channels J increases the efficiency regardless of the number of the channels J.

FIG. 35 is a diagram illustrating efficiency for p=0.05 and a payload length of 30 bytes in an IP communication system according to the second embodiment of the present invention.

It can be noted from FIG. 35 that an increase in the number of channels J used in the IP communication system increases the efficiency. In particular, it can be understood from FIG. 35 that the increase in the number of channels J increases the efficiency regardless of the number of the channels J, and compared with the efficiency described with reference to FIG. 34, the efficiency increases with the payload length.

If the J channels are asynchronous channels, i.e. if the J channels have different delay characteristics, a buffer size of a receiver should be taken into consideration. Before a description of the buffer size of the receiver is given, a description will now be made of a method for estimating a time difference between a packet first received at the receiver and a last received packet among the packets transmitted through the J channels.

It is assumed that in the IP communication system, one IP packet is segmented into a plurality of, for example, D medium access control (MAC) packets and reliable MAC transmission is possible. The “reliable MAC transmission” refers to MAC transmission that retransmits a defective MAC packet, thereby increasing transmission reliability. For the reliable MAC transmission, although the number of retransmissions for a defective MAC packet is not limited, it will be assumed herein that the number of retransmissions is limited to a jitter Δ. In addition, it will be assumed that the asynchronous channels are equal to synchronous channels in terms of the network overhead, efficiency and PEP, and a unit time refers to a time for which one MAC packet transmitted from a transmitted is received at a receiver. If a time at which the last MAC packet of one IP packet has arrived is t=0, it means that no retransmission for the MAC packet has occurred. The time difference between the first received packet and the last received packet will be referred to as an “expected arrival time,” and the expected arrival time can be represented by a random parameter T when the unit time is expressed as ‘1’. Therefore, the T is expressed as integers greater than 0 (0≦T≦∞).

Therefore, if k retransmissions are required for successfully receiving the D MAC packets, a time at which one IP packet is fully received becomes t=k, and it indicates that when (D+k) MAC packets are transmitted, D MAC packets are normally received and k MAC packets are lost. If the last MAC packet is normally received, the probability distribution of the expected arrival time T can be expressed as

$$Pr ( T = k ) = ( D + {k}_{k} - 1 ) {( 1 - p )}^{D} {p}^{k} \qquad ( 14 )$$

Assuming that the arrival times of the IP packets transmitted through an i^{th} channel are denoted by dᵢ and an arrival time of the last IP packet is represented by d=maxᵢdᵢ, the probability distribution of the arrival time d of the last IP packet can be expressed as

$$Pr ( d = k ) = {\sum }_{i = 1}^{I} ( {J}_{i} ) {Pr ( T = k )}^{i} {F ( k )}^{J - i} \qquad ( 15 )$$

In Equation (15), ‘F’ denotes an accumulated distribution function of the expected arrival time T. As shown in Equation (15), it is necessary to wait for k unit times to receive all of IP packets.

Assuming that the jitter Δ is equal to the k, n_{B} IP packets among all of the IP packets are received at a time t=i, n_{E} IP packets are received at a time t=i+k, and the other IP packets except for the (n_{B}+n_{E}) IP packets are received within a predetermined time period [i+1, i+k−1]. In order to detect the probability that the jitter Δ will be equal to the k, it is necessary to sum up i probabilities that the jitter Δ is equal to the k and the first IP packet is received at a time t=i, as shown below.

$$Pr ( Δ = k ) = {\sum }_{i = 0}^{∞} {\sum }_{{n}_{B} = 1}^{J - 1} {\sum }_{{n}_{E} = 1}^{J - {n}_{B}} ( {J}_{{n}_{B}} ) ( {J - {n}_{B}}_{{n}_{E}} ) {Pr ( T = i )}^{{n}_{B}} {Pr ( T = i + k )}^{{n}_{E}} {( {\sum }_{I = i + 1 = 0}^{k + i - 1} Pr ( T = l ) )}^{J - {n}_{B} - {n}_{E}} \qquad ( 16 )$$

Equation (16) shows the probability that the jitter Δ will be equal to the k, for k≧2.

The probability that the jitter Δ will be equal to the k, for k=0, is expressed as

$$Pr ( Δ = 0 ) = {\sum }_{i = 0}^{∞} {Pr ( T = i )}^{J} \qquad ( 17 )$$

The probability that the jitter Δ will be equal to the k, for k=1, is expressed as

$$Pr ( Δ = 1 ) = {\sum }_{i = 0}^{∞} {\sum }_{{n}_{B} = 1}^{J - 1} ( {J}_{{n}_{B}} ) {Pr ( T = i )}^{{n}_{B}} {Pr ( T - i + 1 )}^{J - {n}_{B}} \qquad ( 18 )$$

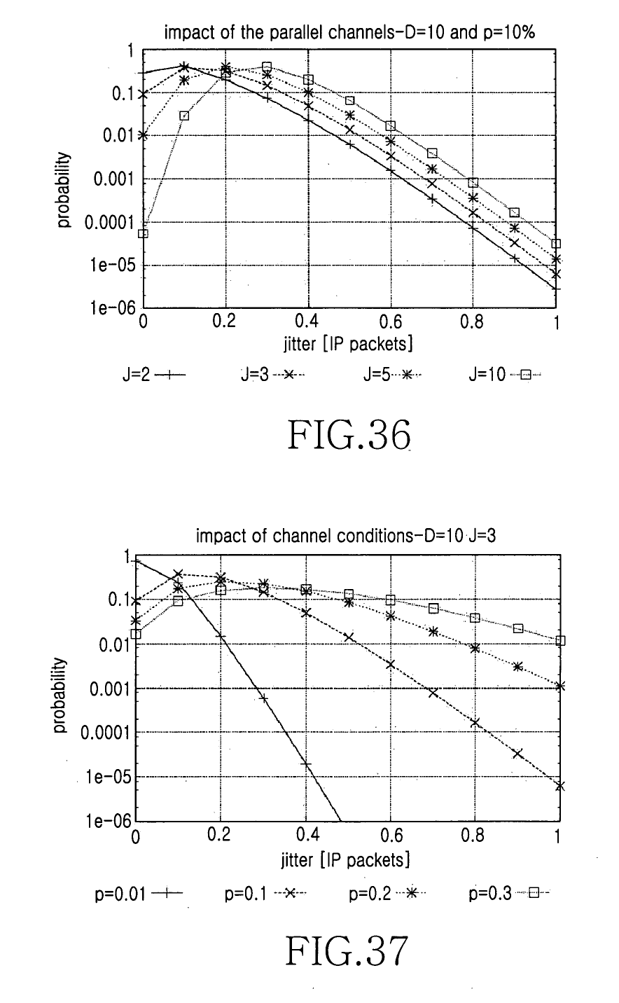

The simulation results shown in FIGS. 36 to 38 can be derived from Equation (16) to Equation (18).

FIG. 36 is a graph illustrating an impact of the number of channels J used in embodiments of the present invention for a fixed D and a fixed p.

FIG. 36 shows an impact of the number of channels J for D=10 and p=10%, and shows that a variation in buffer size according to the number of channels J is insignificant.

FIG. 37 is a graph illustrating an impact of MAC packet error probability in an IP communication system according to embodiments of the present invention.

FIG. 37 shows that an impact of the MAC packet error probability is significant, and that a buffer size for IP packets can be reduced to vary the MAC packet error probability.

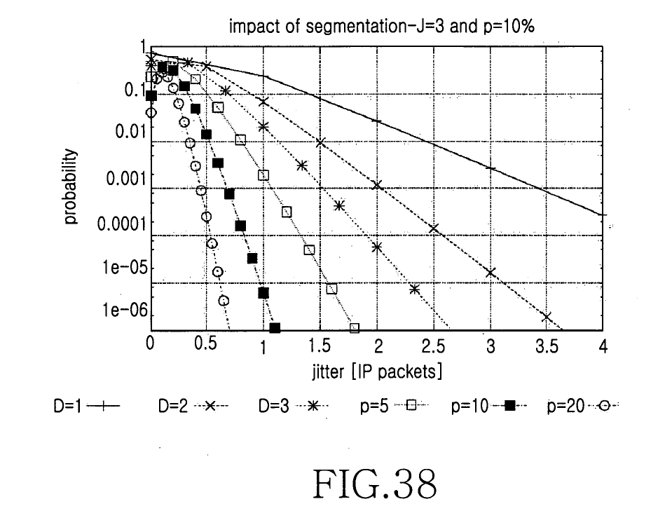

FIG. 38 is a graph illustrating an impact of a segmentation level in an IP communication system according to embodiments of the present invention.

It can be noted from FIG. 38 that a decrease in the number D of MAC packets constituting one IP packet increases a buffer size, and the impact shown in FIG. 38 is provided on the assumption that the MAC packet error probability is fixed.

As can be understood from the foregoing description, the novel apparatus and method can ensure reliable header information transmission/reception by copying an AIC in all of the parallel channels except for a corresponding channel, before transmission, or copying the AIC in only the channels related to a corresponding channel, except for the corresponding channel, before transmission. Advantages of the present invention are as follows.

(1) High band efficiency acquired

(2) Low memory capacity required (low cost required)

(3) Low complexity

(4) Robustness against header information transmission/reception

(5) Unnecessity of feedback channel

(6) Availability of various protocols

(7) Availability of multiple channels (efficiency can be maximized with the use of a less number of channels)

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting header information in a wireless communication system using a plurality of channels, the method comprising the steps of:
upon receiving uncompressed header (UCH) information, generating compressed header (CH) information and additional information container (AIC) information by compressing the UCH information; and
transmitting the CH information through a first channel among the plurality of channels, and transmitting the AIC information through at least one of the plurality of channels except for the first channel.

2. The method of claim 1, wherein the AIC information includes a part of the CH information.

3. A method for transmitting header information in a wireless communication system using a plurality of channels, the method comprising the steps of:
upon receiving uncompressed header (UCH) information, generating compressed header (CH) information and additional information container (AIC) information by compressing the UCH information; and
transmitting the CH information through a first channel among the plurality of channels, and transmitting the AIC information through at least one channel related to the first channel among the plurality of channels except for the first channel.

4. The method of claim 3, wherein the AIC information includes a part of the CH information.

5. A method for transmitting header information in a wireless communication system using a plurality of channels, the method comprising the steps of:
upon receiving uncompressed header (UCH) information to be transmitted through a first channel among the plurality of channels, generating compressed header (CH) information by compressing the UCH information;
upon receiving UCH information to be transmitted through each of the plurality of channels except for the first channel, generating additional information container (AIC) information for each of the plurality of channels except for the first channel by compressing the UCH information to be transmitted through each of the plurality of channels except for the first channel; and
transmitting the CH information and the AIC information through the first channel,

6. The method of claim 5, further comprising the step of, upon receiving UCH information to be transmitted through the first channel, transmitting the UCH information through the plurality of channels except for the first channel.

7. The method of claim 6, wherein the AIC information includes a part of the CH information.

8. A method for transmitting header information in a wireless communication system using a plurality of channels, the method comprising the steps of:
upon receiving uncompressed header (UCH) information to be transmitted through a first channel among the plurality of channels, generating compressed header (CH) information by compressing the UCH information;
upon receiving UCH information to be transmitted through each of the channels related to the first channel among the plurality of channels, generating additional information container (AIC) information for each of the related channels by compressing the UCH information to be transmitted through the related channels; and
transmitting the CH information and the AIC information through the first channel.

9. The method of claim 8, further comprising the step of, upon receiving UCH information to be transmitted through the first channel, transmitting the UCH information through the related channels.

10. The method of claim 9, wherein the AIC information includes a part of the CH information.

11. An apparatus for transmitting header information in a wireless communication system using a plurality of channels, the apparatus comprising:
a compressor for, upon receiving uncompressed header (UCH) information, generating compressed header (CH) information and additional information container (AIC) information by compressing the UCH information; and
a transmitter for transmitting the CH information through a first channel among the plurality of channels, and transmitting the AIC information through at least one of the plurality of channels except for the first channel.

12. The apparatus of claim 11, wherein the AIC information includes a part of the CH information.

13. An apparatus for transmitting header information in a wireless communication system using a plurality of channels, the apparatus comprising:
a compressor for, upon receiving uncompressed header (UCH) information, generating compressed header (CH) information and additional information container (AIC) information by compressing the UCH information; and
a transmitter for transmitting the CH information through a first channel among the plurality of channels, and transmitting the AIC information through at least one channel related to the first channel among the plurality of channels except for the first channel.

14. The apparatus of claim 13, wherein the AIC information includes a part of the CH information.

15. An apparatus for transmitting header information in a wireless communication system using a plurality of channels, the apparatus comprising:
a compressor for, upon receiving uncompressed header (UCH) information to be transmitted through a first channel among the plurality of channels, generating compressed header (CH) information by compressing the UCH information, and upon receiving UCH information to be transmitted through each of the plurality of channels except for the first channel, generating additional information container (AIC) information for each of the plurality of channels except for the first channel by compressing the UCH information to be transmitted through each of the plurality of channels except for the first channel; and
a transmitter for transmitting the CH information and the AIC information through the first channel.

16. The apparatus of claim 15, further comprising a deliverer for, upon receiving UCH information to be transmitted through the first channel, delivering the UCH information to the plurality of channels except for the first channel.

17. The apparatus of claim 16, wherein the AIC information includes a part of the CH information.

18. An apparatus for transmitting header information in a wireless communication system using a plurality of channels, the apparatus comprising:
a compressor for, upon receiving uncompressed header (UCH) information to be transmitted through a first channel among the plurality of channels, generating compressed header (CH) information by compressing the UCH information, and upon receiving UCH information to be transmitted through each of the plurality of channels related to the first channel, generating additional information container (AIC) information for each of the related channels by compressing the UCH information to be transmitted through the related channels; and
a transmitter for transmitting the CH information and the AIC information through the first channel.

19. The apparatus of claim 18, further comprising a deliverer for, upon receiving UCH information to be transmitted through the first channel, delivering the UCH information to the related channels.

20. The apparatus of claim 19, wherein the AIC information includes a part of the CH information.

21. A method for receiving header information in a wireless communication system using a plurality of channels, the method comprising the steps of:
receiving compressed header (CH) information through a first channel among the plurality of channels, the CH information being generated by compressing uncompressed header (UCH) information;
receiving additional information container (AIC) information through the plurality of channels except for the first channel, the AIC information being generated by compressing the UCH information; and
restoring the CH information into the UCH information by decompressing the CH information.

22. The method of claim 21, further comprising the step of restoring the UCH information using the AIC information if the CH information cannot be restored.

23. The method of claim 22, wherein the AIC information includes a part of the CH information.

24. A method for receiving header information in a wireless communication system using a plurality of channels, the method comprising the steps of:
receiving compressed header (CH) information through a first channel among the plurality of channels, the CH information being generated by compressing uncompressed header (UCH) information;
receiving additional information container (AIC) information through the channels related to the first channel among the plurality of channels, the AIC information being generated by compressing the UCH information; and
restoring the CH information into the UCH information by decompressing the CH information.

25. The method of claim 24, further comprising the step of restoring the UCH information using the AIC information if the CH information cannot be restored.

26. The method of claim 25, wherein the AIC information includes a part of the CH information.

27. An apparatus for receiving header information in a wireless communication system using a plurality of channels, the apparatus comprising:
a receiver for receiving compressed header (CH) information through a first channel among the plurality of channels, the CH information being generated by compressing uncompressed header (UCH) information, and receiving additional information container (AIC) information through the plurality of channels except for the first channel, the AIC information being generated by compressing the UCH information; and
a decompressor for restoring the CH information into the UCH information by decompressing the CH information.

28. The apparatus of claim 27, wherein the decompressor restores the UCH information using the AIC information if the CH information cannot be restored.

29. The apparatus of claim 28, wherein the AIC information includes a part of the CH information.

30. An apparatus for receiving header information in a wireless communication system using a plurality of channels, the apparatus comprising:
a receiver for receiving compressed header (CH) information through a first channel among the plurality of channels, the CH information being generated by compressing uncompressed header (UCH) information, and receiving additional information container (AIC) information through the channels related to the first channel among the plurality of channels, the AIC information being generated by compressing the UCH information; and
a decompressor for restoring the CH information into the UCH information by decompressing the CH information.

31. The apparatus of claim 30, wherein the decompressor restores the UCH information using the AIC information if the CH information cannot be restored.

32. The apparatus of claim 31, wherein the AIC information includes a part of the CH information.
